(19) United States
(12) Patent Application Publication
(10) Pub. No.: US 2015/0232732 A1
(43) Pub. Date: Aug. 20, 2015

(54) THERMALLY CONDUCTIVE POROUS MEDIA

(71) Applicants: Gerald A. DiBattista, Peachtree City, GA (US); Tamara Lee Mace, Marietta, GA (US); James P. Wingo, Peachtree City, GA (US); Guoqiang Mao, Peachtree City, GA (US)

(72) Inventors: Gerald A. DiBattista, Peachtree City, GA (US); Tamara Lee Mace, Marietta, GA (US); James P. Wingo, Peachtree City, GA (US); Guoqiang Mao, Peachtree City, GA (US)

(73) Assignee: Porex Corporation, Fairburn, GA (US)

(21) Appl. No.: 14/344,212

(22) PCT Filed: Sep. 14, 2012
(86) PCT No.: PCT/US2012/055286

§ 371 Date: Mar. 11, 2014

Related U.S. Application Data
(60) Provisional application No. 61/535,052, filed on Sep. 15, 2011.
(60) Provisional application No. 61/588,791, filed on Jan. 20, 2012.
(60) Provisional application No. 61/592,259, filed on Jan. 30, 2012.

(30) Foreign Application Priority Data
Sep. 14, 2012 (TW) 101133622

(51) Int. Cl. C09K 5/14; F21V 29/15; F21V 3/04

(52) U.S. Cl. CPC C09K 5/14; F21V 3/0436; F21V 29/15; F21Y 2101/02

(57) ABSTRACT

The present invention relates to compositions comprising a thermally conductive porous media, optionally linked to a heat spreading interfacial material. These compositions provide heat dissipation from a heat source. These compositions can be used in a variety of applications including effective removal of heat from electronic and other enclosed devices.

### FIELD OF THE INVENTION

The present invention relates to compositions comprising thermally conductive, porous media, optionally connected to a heat spreading interface, which provide heat dissipation. The media may be a thermally conductive, sintered porous plastic media. The heat spreading interface may be a metallic material, non-metallic material or a ceramic material. These compositions can be used in a variety of applications including effective removal of heat from heat sources in electronic and other electrical devices and enclosures.

### BACKGROUND OF THE INVENTION

Excessive heat generated by electronic components has been the major cause of damage to electronic components and electronic devices, and greatly affects their performance. There is a market need for better thermal management. Management of heat dissipation is an important issue for many devices, including electronic devices. Such electronic devices include but are not limited to computers, cell phones, lights, hand-held electronic devices such as personal digital assistants (PDA) and smartphones, stationary electronic devices such as electronic control panels, and devices employing light emitting diodes (LEDs). Key concerns for optimal thermal management include generating heat sinks that can quickly dissipate the heat from the heat sink to the environment and creating an intimate interface between the heat source and heat sink to ensure effective transfer of heat away from the heat source.

It is well known that interfaces between two different materials and two different components in an electronic device have a great impact on the lifespan of electronic devices. A poor interface will result in uneven flow of heat and electricity, and will generate localized hot spots and weak mechanical spots. The electronic devices are likely to break down much faster at the interface because cooling and heating cycles generate great stress at the interface between the two materials or two components.

Various techniques to effect heat dissipation have been used, such as conductive metals (such as aluminum), conductive plastics, open vents and active cooling (fans). Major limiting factors in effective thermal control include air flow and exposed surface area, which are often difficult to attain in many electrical devices. One challenge to achieve good heat dissipation is obtaining enough exposed surface area to allow heat to be transferred to the surroundings. An example is high brightness LEDs, which are efficient light sources; however, even at a light conversion rate of 40-60% of the input power, several watts of heat can still be generated. If not properly managed, this heat will build up and could cause a premature failure of the LED chip. Current technology incorporates a metal (usually aluminum) heat sink which in many cases doubles as part of the light enclosure housing. Since many of these lighting packages are relatively small in size and located in stagnant air flow conditions, such as the typical canned lighting in a ceiling for example MR16 or PAR 30 spot light forms, and air flow around these light forms can be low—thus a key factor in efficient heat transfer is maximizing the effective exposed surface area.

A simple heat transfer through a plate can illustrate the issue.
A=surface area of the plate in m²
k=material thermal conductivity in W/mK
Q=heat flow in W
T=plate thickness in m
h=heat transfer coefficient in W/m²K
T₁=Temperature on side 1 of the plate
T₂=Temperature on side 2 of the plate
Tₐ=Ambient temperature

Heat conduction is governed by Fourier's law as in the following equation:

Q=kA(T₁−T₂)/T

The steady state form of Newton's law of cooling is governed by the following equation:

Q=hA(T₂−Tₐ).

The convective heat flow is primarily controlled by air flow rate and heat sink surface area. Surface area is the variable which can be readily controlled in the natural convection system utilized in these LED lamps. Increasing the surface area increases the volume of thermal energy released to the air; the key to lower temperatures. Prior art means of adding surface area has been the addition of fins and other features, or developing complex shapes to add functionality and thermal management into a single component, some of which are costly.

The thermal interface between the heat source and the heat sink is also important to total system functionality. There are many references in current electronics literature that describe the close relationship of the effective life of the LED and the LED junction temperature. For instance, one study found that if an LED were to successfully operate for 60,000 hours, the operating temperature would have to be 124° C. or below. In fact, if the operating temperature of the LED junction increased only a few degrees to 130° C., the life expectancy dropped by half or to 30,000 hours, Azar, K., et al., 2009, “LED lighting: A case study in thermal management”, Qpedia Thermal E-Magazine, September, 2009.

Heat conduction of materials is measured in W/mK (watts per meter—degree Kelvin). Common materials currently used for heat sinks are aluminum (between 100-300 W/mK), ferrous metals (40-75 W/mK), copper (about 400 W/mK) and heat conductive plastics (1-30 W/mK). Since the heat conductivity values measured in thermally conductive plastics are lower than those of aluminum, studies have been done to understand if materials are required to be at 100+W/mK in order for the product to function effectively. Findings reveal that both heat conductivity and convection are key performance criteria for the end product. In designs such as a LED, where a single or dual direction heat supply is found, convection is limiting before the conductivity of the product. See Compounding World, February 2010, pp. 39-42. Therefore materials with lower values in thermal conductivity may be useful without significant reduction in product performance as long as sufficient exposed surface area is available.

Expected continuous operating temperatures for a typical LED light can range between 60-110° C. If temperatures reach more than 125° C., a dramatic decrease in LED chip life can result. This is unacceptable to the consumer and can cause warranty issues for the manufacturer. In addition, applications in which live alternating current (AC) is used are required to meet certain Underwriters Laboratories (UL) ratings. Plastics materials used in electronics usually have to meet the UL-94 standard for flammability of plastic components, while a new standard for LED lighting, UL-8750 is widely being adopted by the industry.

Current LED lighting device housings are typically made from casted, extruded or machined aluminum or injection molded conductive polymers. These housings are typically solid. To improve the thermal conductivity and heat removing capability, the housings are designed with fins or other features to increase the surface area. Since these designs can be complicated, the cost for these housings can be high, and high volume production may be difficult. Also, metal casting and injection molding limitations require a certain wall thickness which requires more material than otherwise necessary to achieve the desired exposed surface area, thereby increasing the weight and cost of the final product.

To improve the heat removing properties of light housings, one approach is to use high thermally conductive materials. However, this approach is limited by the material cost and physical properties and complexity of making non-conductive polymers into conductive polymers. Another approach is to increase the surface area of the light housing, in this case more heat will be radiated out of the device, but available space is often limited.

All materials will conduct some heat and some are better than others although there is always an interaction between cost and performance. The most widely used method to improve thermal conductivity is to add thermally and/or electrically conductive materials such as metal and carbon (graphite) based materials to the marginally heat conductive material. There is also a need to have material that is heat conductive while being electrically isolating. This is typically done by using ceramic type materials such as aluminum nitride or boron nitride or polymers filled with such materials.

Another important aspect of good thermal management is to have good interfacial contact between the heat source and the heat sink. Any inefficiency in the boundary layers between the source and the sink will cause higher thermal resistance and additional heating. Current art utilizes thermal interface greases or other materials to fill any potential gaps or highly smoothed contact surfaces. Most current solutions add steps that are costly, or can be done improperly.

There is an unmet need for a low cost, efficient heat dissipation solution for the electrical market, particularly the LED lighting and computing markets, which can be reliably manufactured in high volume. Finding the optimal cost/performance balance for the LED and other electronics markets is critical to the success of these products within their specific market.

### SUMMARY

The present invention solves these problems by providing a composition comprising a low cost, porous heat dissipation material for the market which can be manufactured in high volume. An open cell porous heat sink offers dramatic advantages as it may facilitate additional air movement and naturally provides a high surface area which is critical for thermal convection, especially when air flow is stagnant. Incorporating all these features into one housing component reduces complexity and increases final assembly efficiency. This porous heat dissipation material may be plastic or any other material that can be made with open pores, for example porous metal and porous ceramic. In one embodiment, this porous heat dissipation material may be sintered plastic. The porous heat dissipation materials of the present invention are useful in conducting heat away from a heat source. The present invention also provides a composition comprising a low cost, porous heat dissipation material and a heat spreading interfacial material functionally linked to the porous heat dissipation material, for the electrical market, particularly the LED lighting and computing markets, which can be manufactured in high volume. The compositions of the present invention are useful in conducting heat away from an electrically generated heat source.

The porous plastic media described herein may be employed for heat dissipation in various electronic devices such as computers, cell phones, lights, hand held electronic devices such as personal digital assistants (PDA), and devices employing LEDs. The utilization of the heat sink is important to the functionality of LEDs and other heat generating electronic devices. There is often a limited amount of space and surface area for the heat sink to dissipate the heat generated. In most cases the heat source is a small surface and the heat sink is larger than the heat source contact surface. In this case, heat must distribute throughout the heat sink and not just into the area in contact with the heat source. Optimal performance from heat sinks is seen when all of the available heat sink is fully utilized to dissipate heat.

The porous plastic media described herein have a unidirectional open cell structure with tortuous paths. The open cell structure allows air flow inside the media and carries away the heat in the heat sink. The pore structure, pore size and tortuous paths of porous plastic media also function as a filter that prevents dust and debris deposition on the electronic devices. Many heat sinks made from solid materials with channels could not prevent deposition of dust and debris.

The present invention also provides an interfacial compatible material between the heat source and porous thermally conductive materials. The interface compatible materials in this invention can be different materials such as metals or graphite. The materials can be in different shapes such as a sheet. The purpose of this interfacial compatible material is for quick and uniform dispersion of the heat generated by the heat source, providing a close contact between the heat source and the interfacial material, and having a wide range of heating expansion and cooling shrinkage tolerances.

The interface between the heat source and the heat sink is critical in allowing efficient heat transfer. Improving that interface can increase the transfer of heat and facilitate use of the full surface area and volume of the heat sink to dissipate heat. The heat conductivity of the interface must be good in order for heat to easily flow from the heat generating component of the device into the heat sink.

This invention improves the thermal dissipation efficiency of porous plastic by incorporating a heat spreading interfacial material that is laminated to the porous plastic through a sintering process. During this process, the porous plastic conforms, and depending on the heat spreading interfacial material and its shape, will actually physically bond or laminate to the heat spreading interfacial material. The act of adding heat and pressure dramatically increases the contact surface between the porous plastic and the heat spreading interfacial material, making the composition more efficient in transferring heat. Thus the combination of a high surface area porous conductive plastic and a thermal spreader can be more efficient than more complex and costly alternatives.

The porous plastic heat sink enclosure of the present invention provides the advantage of allowing air to flow directly away from where the heat is generated. This is a benefit over the current solid heat sink technology. This can be done in several ways including using a standard porous product, using a porous product with a heat conductive additive or utilizing a heat conductive plastic material that is made porous.

Processes that can be employed to yield an open porous structure for this application include, but are not limited to: sintering polymers; sintering ceramics and metals; reactive foam processes; thermoplastic and thermosetting foam with pore forming agents, temperature induced phase separation and solvent induced phase separation processes; leaching and extraction of soluble components and, bonding thermosetting polymer coated particles. When fusing phenolic resin coated particles, conductive porous media formed may be formed by fusing thermosetting resin coated particles. In this process, thermosetting resins include, but are not limited to, phenolic resins, epoxy resins, polyester resins, urea resins, melamine resins, vulcanized rubber and polyimides. Thermosetting resins may possess electrically conductive or insulating properties and/or thermally conductive properties. The filler materials include, but are not limited to, glass beads, metal beads, and other fillers known to one of ordinary skill in the art.

Another advantage of this present invention is that the need for potting the electronics required for the LED for insulation may be eliminated. An electrically insulating, thermally conductive material can be used to encapsulate the electronic portion of the LED or other electronic device. In one embodiment, the powder is filled around the electronics and then sintered in place, which provides insulation of the electronics from the rest of the device, locks the electronics in place, and provides thermal dissipation of the heat generated from the electronics through the porous material. Sintered porous thermally conductive, but not electrically conductive material may function as an encapsulation media for an electrical circuit. Porous conductive material provides insulation and better heat dissipation properties than traditional solid potting materials. FIG. 3 shows an example LED housing made from porous plastic where the electrically isolating material is used around the electronic components and heat conductive porous plastic makes up the rest of the housing.

It is to be understood that the porous thermally conductive materials of the present invention are not limited to any particular shape or configuration and can take many different forms and shapes depending on the user's needs and preferences.

Porous thermally conductive materials have much higher surface areas than surface areas of solid housings. Porous plastic can have two to several hundred times higher surface areas than solid housings of similar size, depending on the pore size, part size and part shape. Porous conductive materials also have interconnected open channels that allow air to flow. Further, the natural hydrophobicity of plastics tends to resist polar liquids. This combination of high surface area and open structure leads to very effective heat dissipation.

In one embodiment, this composition is made of sintered porous plastic functionally coupled to a heat spreading interfacial material and provides high surface area for heat dissipation and means for high volume manufacturing.

The compositions comprising a porous plastic media functionally coupled to a heat spreading interfacial material described herein may be employed for heat dissipation in various stationary or mobile electronic devices such as computers, cell phones, lights, hand held electronic devices such as personal digital assistants (PDA) and other smart handheld devices, electrical enclosures, and devices employing light emitting diodes (LEDs).

The compositions of the present invention provide the advantage of efficient heat transfer from the heat source to the heat spreading interfacial material and then to the thermally conductive porous plastic media, thereby allowing heat and air to flow directly away from the source of heat generation. This is a benefit over the current solid heat sink technology. This can be done in several ways including using a standard porous product, using a porous product with a heat conductive additive or utilizing a heat conductive plastic material that is made porous, each of which is functionally coupled to the heat spreading interfacial material. Another process is to make a porous plastic housing and then surface treat it with a metal coating or another type of coating that has excellent thermal conductivity characteristics. The surface properties are important to the heat transfer phenomenon, so with a continuous surface coating, the porous plastic heat sink can be treated to become conductive.

By incorporating thermal conductivity into a porous plastic media, thermal management is greatly improved. Since the location of heat generation is almost always within an enclosed device, a porous heat sink/enclosure offers the benefit of additional air movement over the heat source, greatly improving heat transfer. In one embodiment, the conductive polymeric materials described herein can be both thermally conductive and electrically conductive or only thermally conductive. In another embodiment, the conductive polymeric materials described herein can be both thermally conductive and electrically insulating.

Porous conductive materials have much higher surface areas than surface areas of solid housings. Porous plastic can have two to several hundred times higher surface area than solid housings of similar size, depending on the pore size, part size and part shape. Also, these porous conductive materials must have an open pore structure of interconnected channels that allow air to flow. If the pores are closed, the device will act as an insulator which is not beneficial. A composition comprising a combination of porous plastic and heat spreading interfacial material can be more efficient per unit weight versus other known heat conductive materials such as aluminum. Also, this combination is easily moldable to most any three dimensional shape, allowing use of available space and greatly enhancing its potential functionality, especially in portable equipment.

Another advantage of this invention is the increase in heat spreading during the molding process With the in-mold addition of a heat spreader, the heat will reach the polymer interfaces faster as it is spreads through the highly heat conductive material and then into the polymer. The addition of a thermal spreader into the molding process reduces cycle time to make a part and increases manufacturing production rates.

### BRIEF DESCRIPTION OF THE FIGURES

FIG. 1 illustrates results from an experiment to assess the rate of heating of various porous plastic disks.

FIG. 2 is a schematic representation of a porous thermally conductive housing for an LED.

FIG. 3 is a schematic representation an LED housing made from porous plastic where the electrically isolating material is used around the electronic components and heat conductive porous plastic constitutes the rest of the housing.

FIG. 4 is a top view of a hot plate with samples placed on the small aluminum blocks which rest on a heating plate to create a small localized heating point on the (50.8 mm) diameter disk. Left forefront is an aluminum disk, right side shows the non-porous injection molded TC8030 disk and top shows a porous plastic TC8030 disk. All disks are 3 mm thick with 50.8 mm diameter.

FIG. 5 is a side view of same three disks in FIG. 4, sitting on top of 25.4 mm square aluminum blocks which are on top of heating plate.

FIG. 6 is a schematic representation of the heating rates of the three different disks described in the legend to FIG. 4.

FIG. 7 is a schematic representation of temperature differentials of the three different disks described in the legend to FIG. 4.

FIG. 8 Left is a disk of thermally conductive porous plastic. FIG. 8 Right is a thermally conductive porous plastic disk with a layer of HiTherm flexible graphite E Graf Grade SS400 (hereinafter called Graftech paper) from Graftech International co-processed in the mold with the TC8030 micropellets when the porous plastic disk was made.

FIG. 9 is a higher magnification view of a laminate of thermally conductive porous plastic made from Bayer Makrolon TC8030 and a layer of the Graftech paper co-processed in the mold. The surface detail in the image shows that the Graftech paper is embedded in the porous plastic matrix. The surface topography of the porous plastic beneath the Graftech layer is visible.

FIG. 10 presents photographs of three experimental samples used in a hot plate test. Left: A sample of aluminum 14 mm thick and 50.8 mm in diameter weighing 79.5 grams (gm). Middle: An aluminum disk (50.8 mm diameter) with a beveled surface cut to increase surface area weighing 21.40 gm. Right: A disk of thermally conductive porous plastic made from TC8030 with a co-processed layer of Graftech HiTherm paper 0.127 mm thick and weighing 21.30 gm.

FIG. 11 is a graph comparing heating rates of the three materials shown in FIG. 10 in the hot plate test.

FIG. 12 is a graph comparing heating rates of three materials in a hot plate test. Samples compared are a thermally conductive porous plastic disk weighing 21.06 gm, a second disk of the same thermally conductive porous plastic co-processed with a layer of 0.51 mm thick Graftech paper to create a laminate, and finally a disk of the thermally conductive porous plastic simply placed on top of a layer of 0.51 mm thick Graftech paper.

FIG. 13 is a graph comparing heating rates of three materials in a hot plate test. Temperature differentials between the center and the edge of each disk during the hot plate test are shown. Samples compared are a thermally conductive porous plastic disk weighing 21.06 gm, a second disk of the same thermally conductive porous plastic co-processed with a layer of 0.127 mm thick Graftech paper to create a laminate weighing 21.30 gm, and finally a disk of the thermally conductive porous plastic weighing 20.29 gm simply placed on top of a layer of 0.127 mm thick Graftech paper.

FIG. 14 illustrates the results of a hot plate test comparing a standard aluminum disk with a non porous thermally conductive plastic disk and a thermally conductive porous plastic disk co-processed with a layer of Graftech paper as a heat spreader. Temperature differentials between the center and the edge of each disk during the hot plate test are shown.

FIG. 15 illustrates the results of a hot plate test comparing a standard aluminum disk with a nonporous thermally conductive plastic disk and a thermally conductive porous plastic disk co-processed with a layer of Graftech paper as a heat spreader. The heating rates between the center and the edge of each disk during the hot plate test are shown.

FIG. 16 is a schematic representation of another embodiment in which a heat spreader is shown on a surface of a thermally conductive porous plastic.

FIG. 17 is a schematic representation of another embodiment in which a heat spreader is shown on a surface of a thermally conductive porous plastic. In this embodiment the porous plastic component is placed inside an injection molded outer cage which provides a housing but does not provide any heat sink functionality. Note the cage style housing is open and therefore allows air flow through the housing into the porous plastic heat sink.

FIG. 18 is a schematic representation of another embodiment in which a heat source is operationally connected to a heat pump system which is in contact with a thermally conductive porous plastic. In this embodiment, the heat pump acts as the heat spreader when it enters the thermally conductive porous plastic. The heat pump/heat spreader is either laminated post molding or more preferably, molded in process with the heat pump in place, producing an excellent interface between the heat pump and the thermally conductive porous plastic.

FIG. 19 is a schematic representation of another embodiment in which a microprocessor is enclosed with a thermally conductive porous plastic. In this embodiment, the heat spreader is located at the interface between the thermally conductive porous plastic and the microprocessor and is not visible in the drawing.

### DETAILED DESCRIPTION

The present invention provides a low cost, heat dissipation material comprising a thermally conductive porous media which provides high surface area for heat dissipation. In one embodiment, the present invention provides a low cost, heat dissipation material comprising a thermally conductive porous plastic media which provides high surface area for heat dissipation. In another embodiment, the thermally conductive porous plastic media is sintered. This thermally conductive porous plastic media is useful in a variety of applications, such as dissipating heat from electrical devices.

In one embodiment, the present invention provides a composition comprising a cost efficient, porous plastic thermally conductive material functionally linked to a heat spreading interfacial material. The compositions of the present invention are useful in conducting heat away from a heat source. In one embodiment, the heat source is an electrical component in an electrical device. These compositions are useful in a variety of applications, such as dissipating heat from electrical components and electrical devices.

Processes that can be employed to yield an open porous structure for this application include, but are not limited to: sintering polymers; sintering ceramics and metals; reactive foam processes; thermoplastic and thermosetting foam with pore forming agents, temperature induced phase separation and solvent induced phase separation processes; leaching and extraction of soluble components and, bonding thermosetting polymer coated particles. When fusing phenolic resin coated particles, conductive porous media formed may be formed by fusing thermosetting resin coated particles. In this process, thermosetting resins are coated on the surface of filler particles to form composite particles. Then composite particles are loaded into a mold and sintered into porous media by a heating and cooling cycle. In this process, thermosetting resins include, but are not limited to, phenolic resins, epoxy resins, polyester resins, urea resins, melamine resins, vulcanized rubber and polyimides. Thermosetting resins may possess electrically conductive or insulating properties and/or thermally conductive properties. The filler materials include, but are not limited to, glass beads, metal beads, carbon and other fillers known to one of ordinary skill in the art.

The compositions described herein may be employed for heat dissipation in various electronic devices including but not limited to computers, cell phones, lights, hand held electronic devices such as PDAs and portable smart devices, and devices employing LEDs. In one embodiment, these porous plastic media are sintered.

One embodiment of this invention is a sintered porous thermally conductive material for use as the housing for lighting device, specifically as housing for LED device.

One embodiment of this invention is a composition comprising a sintered porous plastic material functionally coupled to a heat spreading interfacial material for use as the housing for lighting device, specifically as housing for LED device. Another embodiment of this invention is the method of making a sintered porous conductive housing that can reduce the assembly steps in making the LED lights.

Several non-limiting embodiments are shown in the Figures.

### Thermally Conductive Sintered Porous Media

Sintered porous media include plastic, metal and ceramic media.

### Properties

Porosity

Sintered, thermally conductive, porous media in the present compositions have average porosity from 10% to 70%, or from 20% to 60%.

Pore Size

Sintered, thermally conductive, porous media in the present compositions have an average pore size from 1 μm to 500 μm, from 5 μm to 400 μm, or from 10 μm to 300 μm.

Density

The density of the sintered, thermally conductive, porous media in the present compositions ranges from 0.2 g/cm³ to 6 g/cm³, from 0.3 g/cm³ to 5 g/cm³, or from 0.4 g/cm³ to 4 g/cm³.

Surface Area

The surface area of the sintered, thermally conductive, porous media in the present compositions ranges from about 0.0001 m²/g to 10 m²/g, from about 0.0002 m²/g to 5 m²/g, from about 0.001 m²/g to 1 m²/g, or from about 0.002 m²/g to 0.5 m²/g.

Thermal Conductivity

The conductive filler materials that are incorporated into porous media in the present compositions have thermal conductivity values greater than 1 watt per meter Kelvin (W/mK), greater than 2 W/mK, greater than 3 W/mK, greater than 4 W/mK, greater than 5 W/mK or greater than 10 W/mK.

The thermally conductive porous media in the present compositions have thermal conductivity values greater than 0.05 W/mK, greater than 0.1 watt W/mK, greater than 0.2 W/mK, greater than 0 3 W/mK, greater than 0.4 W/mK, greater than 0.5 W/mK, greater than 1 W/mK, greater than 2 W/mK, greater than 3 W/mK, greater than 4 W/mK or greater than 5 W/mK, The heat spreading interfacial material should have a thermal conductivity equal to or greater than the thermally conductive porous material used in the heat sink. Thermal or heat conductivity are measured in-plane according to the ASTM 1461 test standard.

The sintered conductive porous media in the present invention meet different UL 94 flame ratings. In one specific embodiment sintered conductive porous media in the present compositions meet Underwriters Laboratories (UL) 94 HB at 3 mm thickness, V2 at 3 mm thickness, V1 at 3 mm thickness or VO at 3 mm thickness.

### Shape

The porous thermally conductive materials of the present invention are not limited to any particular shape or configuration and can take many different forms and shapes depending on the user's needs and preferences. The shape and profile of porous thermally conductive materials can be adjusted to provide optimal performance for heat dissipation and appearance to consumers. The shape and profile of a porous thermally conductive material will vary based on the heating source power, location, number of heating sources and heat dispensing requirements. One specific heating source for this application is a LED light chip in the LED light.

The possible shapes of porous thermally conductive materials include, but are not limited to, a cylinder, platonic solid (including, dodecahedron, hexahedron (cubic), icosahedron, octahedron, tetrahedron), torus (doughnut), quadric (including, cone, ellipsoid, spheroid, sphere, hyperboloid and paraboloid). The shape can also be a combination of these shapes or a portion of these shapes.

Porous thermally conductive materials may also have different profiles in addition to the shape. The profiles include, but are not limited to holes, tunnels, and concave and convex curvatures.

Porous thermally conductive materials may also have different densities in different regions. The heat dispensing in the porous conductive material can be both homogeneous in all different directions and heterogeneous in different directions.

In one embodiment, the porous conductive polymeric materials in the compositions of the present invention are hydrophobic.

In one embodiment, porous conductive polymeric materials in the compositions of the present invention are hydrophobic and have a water intrusion pressure greater than 1 PSI (6.89×10⁻³ MPa).

### Thermally Conductive Polymers

Thermally conductive polymers used to make the thermally conductive porous plastic media are compounded materials comprising polymers and thermally conductive fillers. Thermal conductive properties are provided by the thermally conductive fillers. Mechanical properties and sinterability are provided by the non-conductive polymers.

The fillers are distributed in the polymeric matrix during the compounding process in a way that provides the polymeric matrix with thermal conductivity. This process is well known in the polymer arts. These types of polymeric thermally conductive compounds are widely used in the electronic industry. The polymers that may be compounded with thermally conductive fillers to form thermally conductive polymers include but are not limited to polyethylene, polypropylene, polyester, thermoplastic elastomers (TPE), acrylonitrile butadiene styrene (ABS), polycarbonate (PC), polyamide, polyamine, polyphenylene oxide (PPO), polyphenylene sulfide (PPS), polyethylene terephthalate (PET), polybutylene terephthalate (PBT), phenolic resins, liquid crystalline polymers (LCP) and epoxy, and combinations thereof. These compounded thermally conductive polymers are commercially available from suppliers such as Cool Polymers, Inc. (Kingstown, RI) under the trade names CoolPoly E-Series and CoolPoly D-Series, Sabic Innovative Plastics (Pittsfield, Mass.) under the trade names STAT-KON series products, KONDUIT series, and CYCOLOY series products, RTP products from RTP Corp (Winona, Minn.) and Makrolon and Bayland products from Bayer Material Science (Pittsburgh, Pa.). In some embodiments, polymers that can be used for this application are polyamides (nylons), polycarbonate (PC), ABS, PPS, and blended alloys of polycarbonates with other polymers, such as a blend of PC and ABS, a blend of PC and PBT and a blend of PC and PET. Pellets of these compounded thermally conductive polymers are then reduced to a desired size, for example a size in the range of 50 to 3000 μm in diameter, before sintering.

In another embodiment, metal powders, ceramics and/or carbon (graphite) based materials may be added to particles of plastic before sintering.

In one embodiment, the plastic in the thermally conductive porous plastic media is polycarbonate or ABS, or a blend thereof. In another embodiment, the plastic in the thermally conductive porous plastic media is polycarbonate or ABS, or a blend thereof, and the thermally conductive filler is carbon (graphite).

In one embodiment, the thermally conductive porous plastic media are sintered.

In some embodiments, the conductive polymeric materials in this application are both thermally conductive and electrically conductive.

In another embodiment, the conductive polymeric materials in this application are thermally conductive but electrically insulating.

Compared with other porous materials, thermally conductive porous plastic materials, including sintered porous plastic materials, are more cost effective (compared with metal and ceramic) and more mechanically sound (compared with membranes). Thermally conductive porous plastics materials address the thermal conductivity needs for electronic devices due to the cost, mechanical strength, heat conductivity and air permeability.

### Nonconductive Polymeric Materials

Before forming thermally conductive porous media, thermally conductive polymeric materials are optionally combined with nonconductive polymer particles to form the thermally conductive porous media of the present invention. Such nonconductive polymers include but are not limited to polyethylene, polypropylene, polyester, thermoplastic elastomers (TPE), acrylonitrile butadiene styrene (ABS), polycarbonate (PC), polyamide, for example nylon, polyamine, polyphenylene oxide (PPO), polyphenylene sulfide (PPS), polyethylene terephthalate (PET), polybutylene terephthalate (PBT), phenolic resins, liquid crystalline polymers (LCP) and epoxy, and combinations thereof.

### Conductive Fillers

Conductive fillers may be a metallic material, a non-metallic material or a ceramic material or a combination thereof. A metallic material includes but is not limited to aluminum, copper, ferrous materials, zinc, tin or an alloy of these metals. A non-metallic material includes but is not limited to heat conductive graphite, graphene, thermal grease or quartz. A ceramic material includes but is not limited to boron nitride, silicon carbide or aluminum nitride. In another embodiment, metal particles, ceramics and/or carbon (graphite) based conductive particles may be added to plastic particles before sintering. For example, the ECOPHIT® Graphite Powder from the SGL Group headquartered in Weisbaden, Germany, can be used as conductive particles.

The conductive polymeric particles and nonconductive polymer binding particles generally have a similar particle size. Nonconductive polymer particles are blended together with conductive polymeric particles using a mechanical blender at proportions of from about 1% to 50%, or about 2% to 30% (wt% dry blend, ratio of nonconductive polymer particles to conductive polymeric particles). In one embodiment, the blended particles are then sintered.

Generally, conductive pellets are purchased from a vendor and reduced to conductive particles with a desired particle size distribution. Next, nonconductive binding polymer pellets are purchased from a vendor and reduced to nonconductive binding pellets with a desired particle size. It is to be understood that the use of nonconductive binding particles is optional. Nonconductive binding particles are employed in some embodiments to improve the strength of the sintered part and the strength of the final product. Alternatively, less conductive particles may be employed to improve the strength of the sintered part and final product without using the binding particles. When both conductive particles and binding particles are employed, the conductive particles and binding particles are then mixed together (dry blended) in a desired ratio. The mixture is then sintered into a desired shape to make the profiled product.

In another embodiment particles of nonconductive polymer binders such as polycarbonate/acrylonitrile butadiene styrene (PC/ABS) are dry blended into thermally conductive particles in order to increase part strength.

Both thermally conductive and non-conductive plastic particles used to provide a porous conductive media preferably have an average diameter of from about 5 μm to about 3000 μm, from about 10 μm to about 2500 μm, from about 50 μm to about 2000 μm, from about 100 μm to about 1800 μm, or from about 200 μm to about 1600 μm. However, most thermoplastics are not commercially available in powder form, and must therefore be converted into powder form by methods well known to those skilled in the art such as, but not limited to, cryogenic grinding and underwater pelletizing. See U.S. Pat. No. 6,551,608.

In one embodiment, it is preferred that the particles used to form the porous conductive media are all of about the same size. It has been found that particles of about the same size (+/−25% from the average particle size) can be consistently packed into molds. All polymer particles are in bulk with an inherent particle size distribution. About the same size for polymer particles means the particles are within 25% of the median average particle. A narrow particle size distribution further allows the production of a conductive porous media with uniform porosity (i.e., a conductive porous media comprising pores that are evenly distributed throughout it and/or are of about the same size). This is advantageous because dissipation of heat tends to flow more evenly through uniformly porous media than through porous media which contain regions of high and low permeability. Uniformly porous media are also less likely to have structural weak spots than media which comprise unevenly distributed pores of substantially different sizes. In view of these benefits, if a thermoplastic is commercially available in powder (i.e., particulate) form, it is preferably screened prior to use to ensure a desired average size and size distribution. However, most thermoplastics are not commercially available in powder form, and must therefore be converted into powder form by methods well known to those skilled in the art such as, but not limited to, standard mechanical reducing grinding, cryogenic grinding and underwater pelletizing. See U.S. Pat. No. 6,551,608.

Cryogenic grinding can be used to prepare thermoplastic particles of varying sizes. However, because cryogenic grinding provides little control over the sizes of the particles it produces, powders formed using this technique may be screened to ensure that the particles to be sintered are of a desired average size and size distribution.

Underwater pelletizing can also be used to form thermoplastic particles suitable for sintering. Although typically limited to the production of particles having diameters of greater than about 300 μm, underwater pelletizing offers several advantages. First, it provides accurate control over the average size of the particles produced, in many cases thereby eliminating the need for an additional screening step and reducing the amount of wasted material. A second advantage of underwater pelletizing, which is discussed further herein, is that it allows significant control over the particle shape. Underwater pelletizing is described, for example, in U.S. Pat. No. 6,030,558.

Thermoplastic particle formation using underwater pelletizing typically requires an extruder or melt pump, an underwater pelletizer, and a dryer. The thermoplastic resin is fed into an extruder or a melt pump and heated until semi-molten. The semi-molten material is then forced through a die. As the material emerges from the die, at least one rotating blade cuts it into pieces herein referred to as “pre-particles.” The rate of extrusion and the speed of the rotating blade(s) determine the shape of the particles formed from the pre-particles, while the diameter of the die holes determines their average size. Water, or some other liquid or gas capable of increasing the rate at which the pre-particles cool, flows over the cutting blade(s) and through the cutting chamber. This coagulates the cut material (i.e., the pre-particles) into particles, which are then separated from the coolant (e.g., water), dried, and expelled into a holding container.

The average size of particles produced by underwater pelletizing can be accurately controlled and can range in some non-limiting embodiments from about 300 μm to about 3200 μm in diameter, depending upon the thermoplastic particle size can be adjusted simply by changing dies, with larger pore dies yielding proportionally larger particles. The average shape of the particles can be optimized by manipulating the extrusion rate and the temperature of the water used in the process.

While the characteristics of a porous material can depend on the average size and size distribution of the particles used to make it, they can also be affected by the particles' average shape. Consequently, in another embodiment of the invention, the thermoplastic particles are substantially spherical. The word substantially in this invention means that the particles are not perfectly spherical. The diameter of particles in different directions may vary by less than about 30%. This shape provides specific benefits. First, it facilitates the efficient packing of the particles within a mold. Second, substantially spherical particles, and in particular those with smooth edges, tend to sinter evenly over a well-defined temperature range to provide a final product with desirable mechanical properties and porosity. Table 1 illustrates this point. The ASTM D638 was used for this testing result.

The following Table shows the results of tensile testing done on two sets of thermally conductive porous plastic particles made from Makrolon TC8030. The pelletized sample was been made from uniform rounded micropellets of the Makrolon TC8030. The second column of data on the right side of the table shows the failed results from testing samples made from particles ground from Makrolon TC8030. The second set of samples was ground at room temperature using a Wedco lab attrition mill with 30.5 cm plates. The plates used to grind the base polymer pellets provided by Bayer had a range of between 100-300 teeth per 30.5 cm plate. The polycarbonate base polymer in the TC8030 is very glassy at that temperature range. The resultant particle size and shape from this grinding experiment was very non-uniform shaped and full of non-rounded particles. The particles were more like shards. These particles resulted in such a weak structure when sintered together, that the sample could not even be mounted successfully in the Instron apparatus to allow the tensile test to be performed.

TABLE 1
Strength measurements: ASTM D638 12.7 mm dogbone tensile test
crosshead speed at 50.8 mm per minute Porous plastic TC8030

| | | Pelletized in more | |
|---|---|---|---|
| | | spherical | Particles ground |
| | | shape with | to larger less |
| | | 0.965 mm die | spherical particle size |
| Thickness (mm) | Avg | 3 | 3 |
| Peak load (Kg force) | Avg | 7.20 | too weak to measure |
| Peak Stress (MPa) | Avg | 1.68 | too weak to measure |
| Elongation at break % | Avg | 0.248 | too weak to measure |
| Modulus (MPa) | Avg | 1.37 | too weak to measure |

In a specific embodiment of the invention, the thermoplastic particles are substantially spherical with minimal rough edges. Consequently, if the thermoplastic particles used in this preferred method are commercially available, they are thermal fined to ensure smooth edges and screened to ensure a proper average size and size distribution. Thermal fining, which is well known to those skilled in the art, is a process wherein particles are rapidly mixed and optionally heated such that their rough edges become smooth. Mixers suitable for thermal fining include the W series high-intensity mixers available from Littleford Day, Inc., Florence, Ky.

Thermoplastic particles made using cryogenic grinding are likewise preferably thermal fined to ensure smooth edges and screened to ensure a proper average size and size distribution. Advantageously, however, if the particles are made using underwater pelletizing, which allows precise control over particle size and typically provides smooth, substantially spherical particles, subsequent thermal fining and screening need not be performed.

### Heat Spreading Interfacial Material

The heat spreading interfacial material heat spreading interfacial material comprises a metallic material, a non-metallic material or a ceramic material. The heat spreading interfacial material can be made from numerous materials including but not limited to metallic materials such as aluminum, copper, ferrous materials, zinc, tin and alloys of the above materials; nonmetallic materials such as carbon-based materials, heat conductive graphite, graphene and quartz, and ceramic materials such as boron nitride, silicon carbide and aluminum nitride.

More specific examples of graphite thermal interface materials can be purchased form Graftech International. The HiTherm graphite paper/foil is an excellent example of a good thermal interface material (E Graf Grade SS400). The material has a bulk thermal conductivity of 16 W/mK and is flexible so it can conform easily to surfaces. This material has a significant advantage over thermal interfacial grease, because it doesn't flow or pump over time away from the interface it is supporting.

The heat spreading interfacial material can be used in different forms, including but not limited to beads, pellets, powder, screens, grids, mesh, wires, tubes, sheets and foil. In separate embodiments, sheets and foil are preferred forms. If the heat spreading material has a solid contact surface, perforations in this solid surface will allow for binder flow into the perforations and form mechanical bonding points which secure the two surfaces.

The heat spreading interfacial material efficiently moves heat away from the source of the heat. This heat is next transmitted into the high surface area of the heat conductive porous plastic and is then dissipated into the surrounding air.

In a specific embodiment, the heat spreading interfacial materials have in-line thermal conductivities equal to or greater than the in-line thermal conductivities of porous thermally conductive media.

### Assembling the Thermally Conductive Sintered Porous Plastic Media and the Heat Spreading Interfacial Material

Thermally conductive sintered porous plastic media and the heat spreading interfacial material need to be coupled together tightly. They can be co-sintered together, glued together by conductive adhesives or grease, thermally bonding together with adhesive or without adhesive, or mechanically coupled together, such as by insertion, or screwing together.

In one specific embodiment, the heat spreading interfacial material is co-sintered together with thermally conductive porous media as single piece. Once thermoplastic particles of a desired average size and/or shape have been obtained, they are optionally combined with additional materials such as, but not limited to, binders, lubricants, colorants, and fillers. The porous thermally conductive materials of the invention can optionally comprise additional materials such as, but not limited to, binders, lubricants, colorants, and fillers. Examples of fillers include, but are not limited to, carbon black, cellulose fiber powder, siliceous fillers, polyethylene fibers and filaments, and mixtures thereof. Specific polyethylene fibers and filaments include, but are not limited to, those disclosed by U.S. Pat. Nos. 5,093,197 and 5,126,219.

In one embodiment, after the thermoplastic particles and optional additional materials have been blended, preferably to provide a uniform mixture, the mixture is sintered. In another embodiment when the thermally conductive porous media is combined with a heat spreading interfacial material, the thermoplastic particles and optional additional materials are blended, preferably to provide a uniform mixture, the heat spreading interfacial material is placed in the mold at a desired location, the mixture is added to the mold and the mixture and the heat spreading interfacial material are sintered. Depending on the desired size and shape of the final product (e.g., a block, tube, cone, cylinder, sheet, or membrane), this can be accomplished using a mold, a sheet line such as that disclosed by U.S. Pat. No. 3,405,206, or using other techniques known to those skilled in the art. In one embodiment of the invention, the mixture is sintered in a mold. Suitable molds are commercially available and are well known to those skilled in the art. Other molds may be designed for a specific application, for example to make a housing for an LED device. Specific examples of molds include, but are not limited to, flat sheets with thickness ranging from about 1.5 mm to about 12 mm, round cylinders of varying heights and diameters, and molds designed to provide a housing for an LED device. Suitable mold materials include, but are not limited to, metals and alloys such as aluminum and stainless steel, high temperature thermoplastics, and other materials both known in the art and disclosed herein. It must be noted in making sheet form material, a roll of heat spreading material must be applied either to the top or bottom of the process so the pellets and spreader materials can form an intimate bonding region. These sheets then can be cut using well know methods to the final desired shape.

In another embodiment, the heat conducting porous part is first formed using one of the methods disclosed above and the heat spreader is applied using a secondary heating/pressure process. This can be done in a secondary mold, using a hot stamping process, heat staking process, vibration welding process, various compatible adhesives, or numerous other methods well known in the art of joining materials.

In one embodiment of the invention, a compression mold is used to provide the sintered material. In this embodiment, the mold is heated to the sintering temperature, allowed to equilibrate, and then subjected to pressure. This pressure typically ranges from about 6.89×10⁻³ MPa to about 6.89×10⁻² MPa, depending on the composition of the mixture being sintered and the desired porosity of the final product. In general, the greater the pressure applied to the mold, the smaller the average pore size and the greater the mechanical strength of the final product. The duration of time during which the pressure is applied also varies depending on the desired porosity of the final product, and is typically from about 2 to about 10 minutes, more typically from about 4 to about 6 minutes. In another embodiment of the invention, the thermoplastic particles are sintered in a mold without the application of pressure.

Once the porous media has been formed, the mold is allowed to cool. If pressure has been applied to the mold, the cooling can occur while it is still being applied or after it has been removed. The porous media is then removed from the mold and optionally processed. Examples of optional processing include, but are not limited to, sterilizing, cutting, milling, drilling, polishing, encapsulating, and coating.

In one embodiment, a thermally conductive heat spreading interfacial material is cut to desired size and inserted into a mold. A thermally conductive polymer of specific size and shape to provide the desired pore volume is then added to the mold. The mold is closed and heated to a suitable sintering temperature. The resulting product is a thermally conductive laminate with a heat spreading interfacial material bonded or laminated to the sintered porous plastic substrate.

In following the process above, the heat spreading interfacial material in combination with the heat conductive porous plastic heat sink performs more efficiently than the porous article alone. In addition, if the heat spreading interfacial material is inserted after forming of the sintered porous heat sink (thereby providing the same components) this “Two-step” version of the composition does not transfer heat as efficiently as the version in which the heat spreading interfacial material is sintered together with the porous plastic heat sink and functionally acts as one component. This process also eliminates the need for specific adhesives for binding the heat spreading interfacial material to the porous plastic which adds another interface and can negatively impact thermal conductivity of the system.

The process above also significantly improves the cycle time to produce final components due to the addition of the heat spreading interfacial material in the molding process.

If there is any porosity, small through holes, or other features in the heat spreader materials, then the porous plastics will flow and adhere or laminate to this surface mechanically during the sintering process. Contact area at the interface of the two materials will increase if they are molded together due to the conforming of the plastic particles to the heat spreading interfacial material during sintering. The heat spreading interfacial materials with some natural porosity such as a graphite sheet and many ceramics will form a more permanent laminated bond with the sintered porous plastic. These final products are thus more durable due to the mechanical bonding. Sometimes, low levels of adhesion may be used between the heat spreader and porous heat sink if the surface of the heat spreader is featureless or non-porous (i.e., flat metallic sheet),It is believed that sintering the heat spreading interfacial material to the porous plastic causes the heated plastic to enter pores or pits in the surface of the heat spreading interfacial material, thereby decreasing the amount of voids between the heat spreading interfacial material and the porous plastic, and enhancing the heat transfer through the interface. Trapped air is a poor conductor of heat.

Heat spreading interfacial materials can be physically mounted onto a porous conductive heat sink by mechanical attachment means such as metal screws or nails. In some embodiments, thermal grease or adhesive is applied between the heat spreader and porous conductive heat sink to provide close contact and eliminate poor contact spots. Liquid or gel form adhesive or grease can improve the connection efficiency between the heat spreader and porous heat sink.

In one embodiment of this invention the heat spreading interfacial materials is thermal grease. Thermal grease, also call thermal compound or thermal paste, can be applied between the heat source and porous conductive heat sink to provide consistent and better contact heat transfer between the heat source and porous heat sink.

### Electronic Devices

The compositions comprising thermally conductive porous media, including plastics, metals, and ceramics described herein, optionally in combination with a heat spreading interfacial material, may be employed for heat dissipation in various electronic devices. The compositions described herein may be used with virtually any electronic component or electronic device which generates heat. Some electronic devices include but are not limited to computers, cell phones, lights, hand-held electronic devices such as personal digital assistants (PDA), smartphones, and other smart devices, general electrical and electronic enclosures, and devices employing light emitting diodes (LEDs).

In one embodiment, the heat spreading interfacial material in the composition is placed in the vicinity of a heat producing electronic component. In this embodiment, the heat generated by the electronic component is transferred to the heat spreading interfacial material which then transfers heat to the thermally conductive porous media in the composition. The heat is then transferred to the surrounding environment. The net effect of such heat transfer using the compositions of the present invention is to decrease the heat of the electronic component which prolongs the life of the electronic component and the electronic device housing the electronic component.

The compositions described herein may be made into a variety of shapes, as desired. Virtually any shape may be used, especially if the space is limited. In one embodiment, the composition is made in the form of a housing for an LED light bulb. In another embodiment, the composition is configured to mimic the shape of the heat producing electronic component.

Another shape is a rod shape used in laptop computers to remove and distribute heat from RAM memory and the main processor. In another embodiment, the heat conductive porous plastic could be a flat sheet or insert in an electronic enclosure.

In another embodiment a composition of the present invention can be placed in the vicinity of a chip (integrated circuit) in a computer to draw heat away from the chip while providing electrical isolation.

In another embodiment, the composition is a housing and transfers heat from a light source and is also a housing for the electrical circuit that controls the light.

In a specific embodiment, the composition comprises a porous housing for an LED.

In one embodiment, the LED chip is attached to the composition comprising the thermally conductive porous media.

In one embodiment, the LED chip is attached to the sintered thermally conductive porous media.

In another embodiment, the LED chip is attached to the sintered thermally conductive porous media through a heat spreading interfacial material such as a metal disk or graphene paper used as a heat spreader.

In another embodiment, the LED chip is attached to the sintered thermally conductive porous media through a thermal grease, and the thermal grease functions as a heat spreader.

In yet another embodiment, the sintered conductive porous media has a thermally conductive and electrically insulating region. The region in the housing that uses this material acts as potting for the electrical circuit. In this embodiment, the electrically isolative material encapsulates the electronics and the second higher performing heat and electrically conductive material acts as the primary heat sink.

In another embodiment, the LED chip is attached to or in the vicinity of the surface of the composition containing the heat spreading interfacial material.

In another embodiment, a metallic tube is placed into a mold and thermally conductive porous material is affixed around the tube using one of the methods described above. The tube could be open or closed and a thermal fluid may be sealed within the tube to aid in heat transfer. In this embodiment, the metallic tube is the primary contact surface to the heat source and the porous media is the primary cooling feature.

In yet another embodiment, the heat spreading interfacial material is in the form of a block which is placed in the bottom of a mold, surrounded on all surfaces except one with the thermally conductive polymeric materials and then sintered. The block surface not in contact with the thermally conductive polymeric material is positioned adjacent to the heat source.

In another embodiment, the heat spreading interfacial material has wires or tubes extending therefrom and into the thermally conductive polymeric material to facilitate dissipation of heat.

In another embodiment, the present invention provides an encapsulated LED lighting product comprising a composition comprising a sintered porous plastic media as a housing, which acts as a heat sink, together with a thermally conductive interfacial material located adjacent to the heat producing electronic components, wherein the composition encapsulates the electronics. This is an electrically insulating material with thermal conductivity.

### Method of Using Thermally Conductive Porous Heat Dissipation Media.

The compositions comprising thermally conductive porous media, including plastics, metals, and ceramics described in this application, with and without a heat spreader can be used to dissipate heat from a heat source.

One embodiment of using thermally conductive porous media to dissipate the heat from the heat source is to attach the thermally conductive porous media directly to the heat source and dissipate the heat from the heat source by transferring the heat from the heat source and dissipating the heat into the environment by heat radiation.

Another embodiment of using the thermally conductive porous media to dissipate the heat from the heat source is to attach the thermally conductive porous media to the heat source through a heat spreader and dissipate the heat from the heat source by transferring the heat from the heat source through the thermally conductive porous media and dissipating the heat into the environment by heat radiation.

Still another embodiment of using thermally conductive porous media to dissipate the heat from the heat source is to attach the thermally conductive porous media directly to the heat source and dissipate the heat from the heat source by transferring the heat from the heat source and dissipating the heat into the environment by heat radiation and forced air flow.

Yet another embodiment of using thermally conductive porous media to dissipate the heat from the heat source is to attach the thermally conductive porous media to the heat source through a heat spreader and dissipate the heat from the heat source by transferring the heat from the heat source and dissipating the heat into the environment by heat radiation and forced air flow.

The thermally conductive porous media can be attached to the heat source in many ways, including but not limited to mechanical attachment with screws, with adhesives, physical coupling or encapsulation. The thermally conductive porous media can attach to the heat source on one side, two sides, three sides or may encapsulate the heat source.

The following examples will serve to further illustrate the present invention without, at the same time, however, constituting any limitation thereof. On the contrary, it is to be clearly understood that resort may be had to various embodiments, modifications and equivalents thereof which, after reading the description herein, may suggest themselves to those skilled in the art without departing from the spirit of the invention.

### EXAMPLE 1

Method of Making a Light Housing with Sintered Porous Thermally Conductive Plastic

Numerous techniques are used in the art to assemble an LED lamp and most LED lamps are assembled with some semi-automated equipment and added manual operations. This includes but is not limited to: placing and potting of electronics, joining of multiple sub-components, multiple screws and alignment features, and heat and electrical isolation of certain components. Through the use of the present invention, numerous steps and components can be eliminated, greatly reducing component complexity, labor content and error rate. It would be expected such a design would be more cost efficient than those currently employed, thereby decreasing costs and increasing adoption rates.

In this invention, an LED electronics sub-assembly including LED driver and socket, LED chip, all wiring, and heat spreader are pre-assembled and inserted into a mold designed for a porous plastic housing for an LED bulb. The socket portion rests in a cavity at the bottom of the mold and the LED chip rests at the top of the mold in a designed recess. The mold is then filled with a sinterable plastic powder. The plastics that may be employed are described elsewhere in this application. These plastics include but are not limited to general purpose plastics, engineered thermoplastics, and various filled or compounded materials such as heat conductive plastics. It is to be understood that different types of materials can be used in different regions of the mold for desired specific properties (i.e. an electrically isolating material surrounding the electronics while a thermally conductive material surrounds the LED chipset). Next the plastic powder material in the mold is sintered. The resulting product is a near complete sub-assembly requiring little final finishing, such as a lens or other optical item or addition of a screw base to fit into a light socket.

By utilizing a porous heat sink/enclosure, the heated air can flow directly away from where it is generated, offering a dramatic advantage over the current solid heat sink technology. This can be done in several ways including using a standard porous product, using a porous product with a heat conductive additive, or utilizing a heat conductive plastic material that is made porous, and coating and sintering.

### EXAMPLE 2

### Heat Dissipation Properties of the Sintered Porous Plastic Media Used as Heat Sink for an LED

In order to make a disk of ultrahigh molecular weight polyethylene (UHMWPE), UHMWPE with an average particle size of about 150 μm were processed at 193° C. for 6 minutes in a carver press at 2.76×10⁻¹ MPa, allowed to cool and then disks were removed from the mold. These disks had average pore size of about 35 microns and porosity of about 45%.

Porous PC/ABS (polycarbonate/acrylonitrile butadiene styrene) disks were made by grinding Bayblend FR3030 conductive PC/ABS resin (Bayer, Pittsburgh, Pa.) into particle sizes in the range of about 50 to 300 μm. Using the same mold as described below, the mold was filled with the dry blend, the lid placed on top and pressure applied in the heated press. The particles were processed at 232° C. for 12 minutes in a carver press at 2.76×10⁻¹ MPa, allowed to cool and then disks were removed from the mold. These disks had average pore size of about 100 microns and porosity of about 47%.

The samples manufactured using the underwater micropelletized Cool Poly E4501 conductive PC resin (Cool Polymers, North Kingstown, R.I.) with average particle size about 500 microns were sintered at high temperature (343° C.) for relatively long times, more than 10 minutes, in comparison with standard UHMWPE codes with no thermally conductive component. An aluminum mold with a lid and a high temperature press were employed. The mold was filled with the dry blend, the lid placed on top, and pressure was applied in the heated press for more than 10 minutes at 343° C. Then the mold was allowed to cool in the press. The mold was removed and the molded parts (disks) were removed. These disks had average pore size of about 90 microns and porosity of about 30%.

A standard lab hot plate (Thermolyne Type #1900) with a upper surface of 20.3 cm×20.3 cm was plugged in and set for 104° C. The porous plastic disks were manufactured using a mold that produced a disk of 2.06 cm in diameter and 0.25 cm thick. The porous plastic disks were placed on the surface of the hot plate using a sheet of paper to slide them on, so that they all contacted the surface at the same time. A FLIR T 400 model thermal imaging camera was used to collect temperature data across time with collection points at 10 second intervals as the samples heated up on the hot plate (FLIR Systems, Boston, Mass.). FLIR quick report software was used to analyze the images taken across time and the data was graphed.

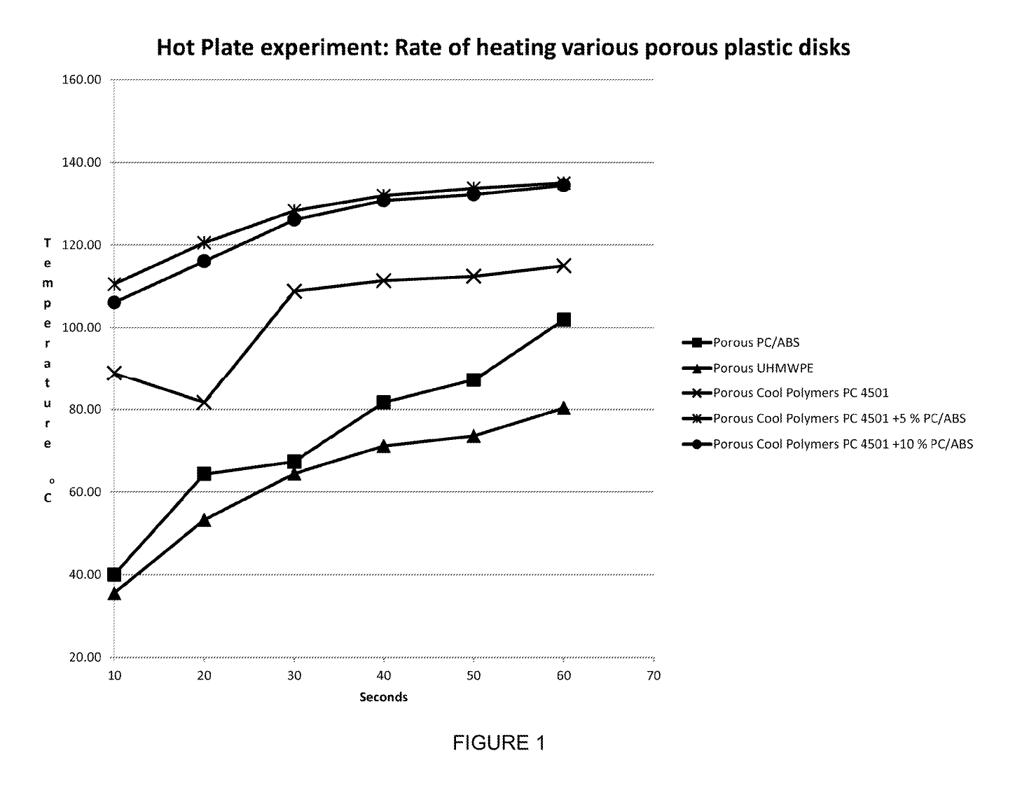

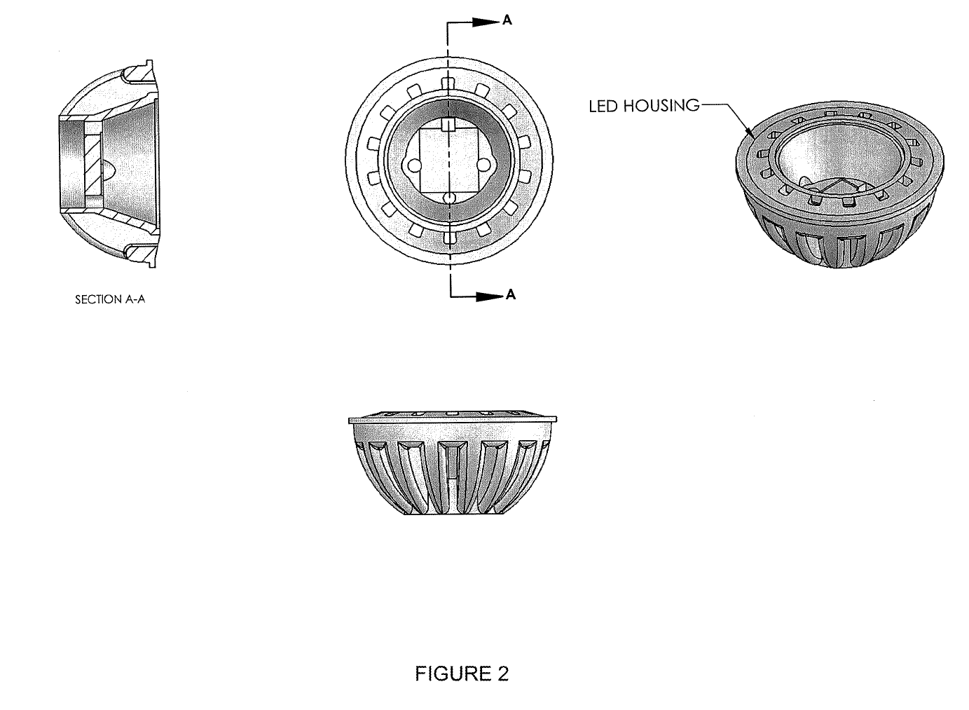

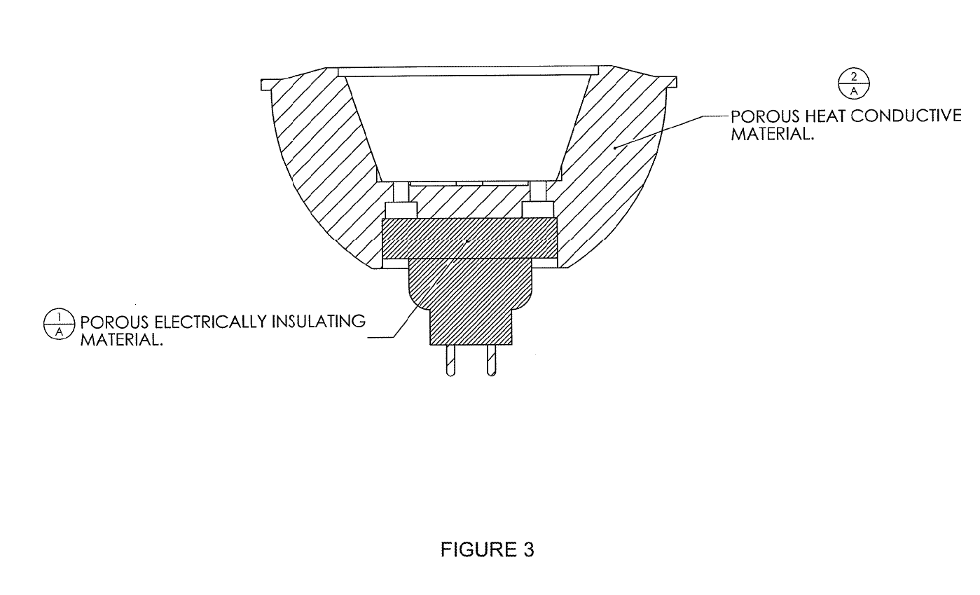

The results are shown in FIG. 1, and demonstrate that the disks made from sintered Cool Poly E4501 with 5% or 10% Bayblend FR 3030 PC/ABS obtained from Bayer (Pittsburgh, Pa.) were the most efficient at thermal conduction, followed by disks made from sintered Cool Poly E4501 without PC/ABS (Note that 5% and 10% refer to wt % in the dry blend of Cool Poly E4501 with 5% or 10% Bayblend FR 3030).

### EXAMPLE 3

Porous polycarbonate (PC) disks were made by underwater micropelletizing Makrolon TC8030 conductive PC resin (Bayer, Pittsburgh, Pa.) into an average particle size of 500 microns. An aluminum mold was filled with the dry blend, the lid placed on top and pressure applied in the heated press. The particles were processed at 343° C. for 10 minutes in a carver press at 2.76×10⁻¹ MPa, allowed to cool, and then disks were removed from the mold. These disks had an average pore size of about 88 microns and porosity of about 29%.

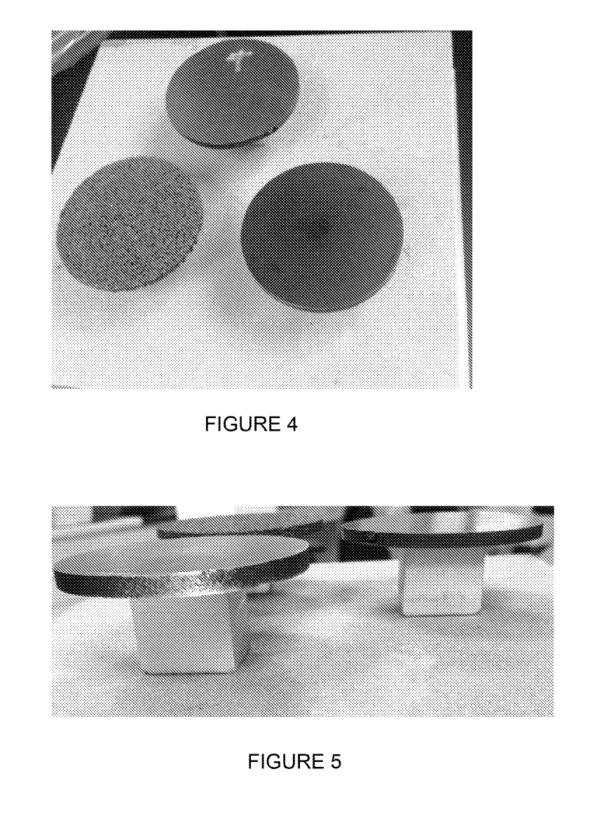

Heating experiments were done to compare the heating rates and heat distribution among three samples: a 50.8 mm diameter 3 mm thick disk of injection molded Bayer Makrolon TC8030 (Top of FIGS. 4 and 5); a 50.8 mm diameter 3 mm thick disk of porous plastic made from micropelletized Makrolon TC8030 (using a 0.965 mm diameter die to pelletize) (bottom left of FIGS. 4 and 5); and a 50.8 mm diameter 3 mm thick disk of aluminum 2024 mold grade (bottom right of FIGS. 4 and 5).

The heat plate used to generate the heat was a Thermolyne brand Hot Plate type 1900 set at 150° C. 25.4 mm square aluminum blocks were placed on the 20.3 cm×20.3 cm heating plate surface and then 50.8 mm diameter disk samples for testing were placed on top of these small aluminum blocks. (See FIGS. 4 and 5).

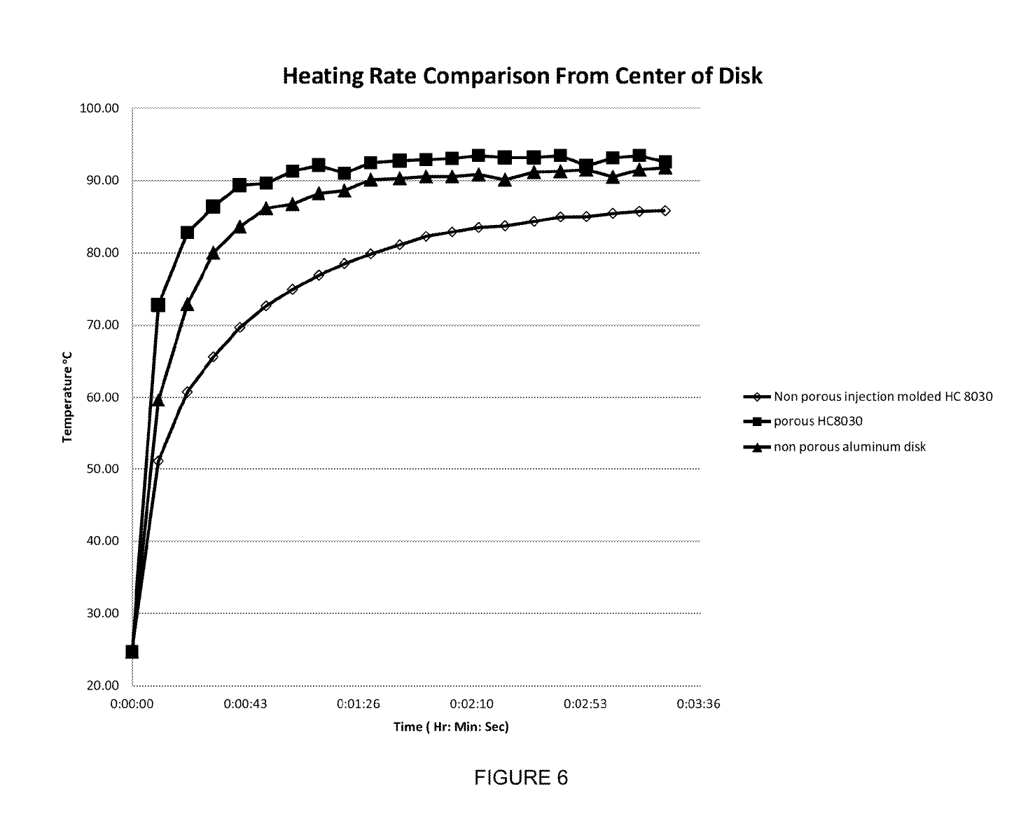

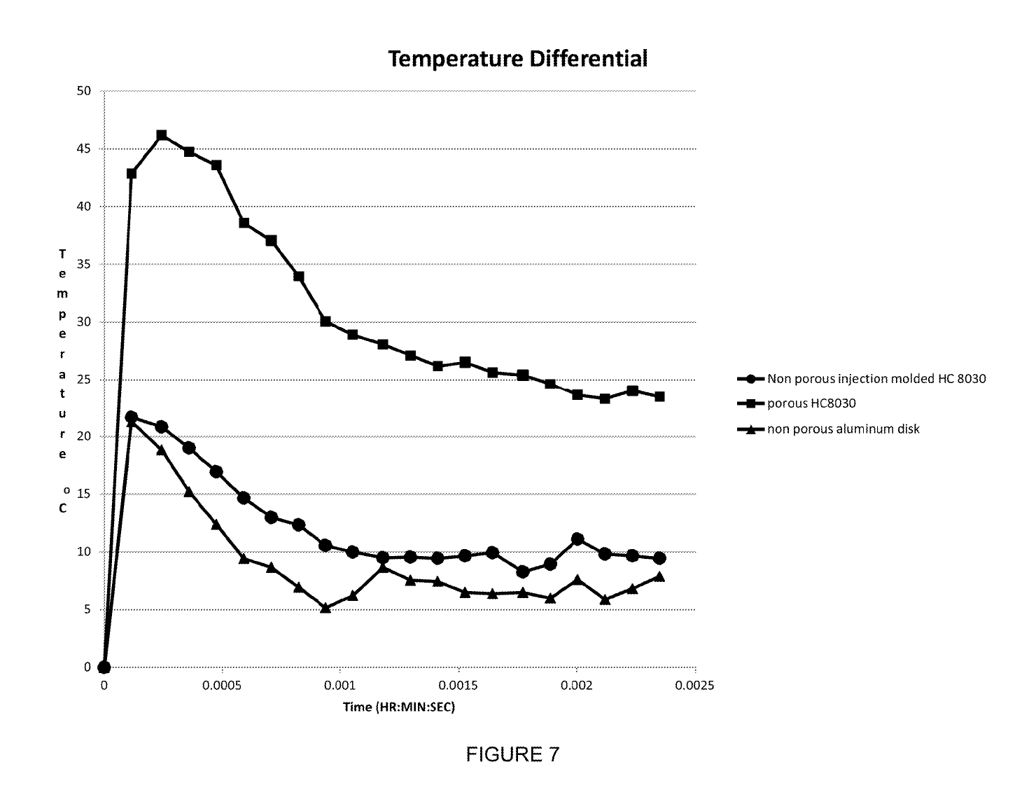

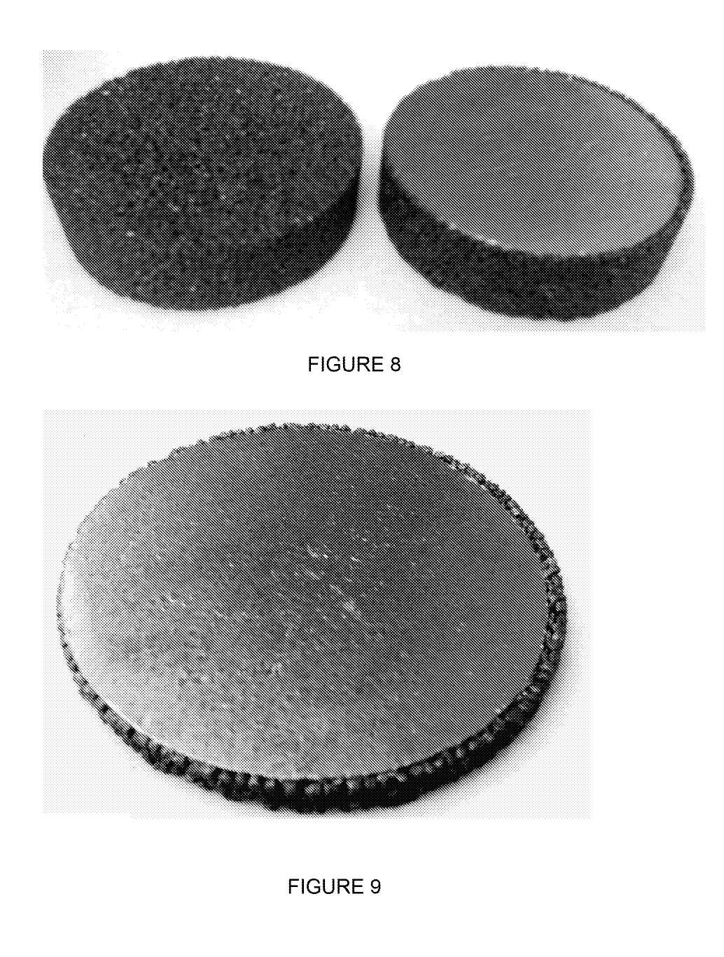

The samples were placed on the aluminum blocks simultaneously in order to compare the rate of heating. Those aluminum blocks were allowed to preheat on the surface of the hot plate for 20 minutes prior to beginning the heating rate test. A Flir T 400 model thermal imaging camera was used to collect snap shots of the hot plate surface and the three samples every 10 seconds for several minutes in order to provide temperature data over time. Flir Quick Report software was used to analyze the snap shots and gather temperature data across time in various locations on the experimental samples. An example of the data and MR quick report images is shown in FIGS. 6 and 7.

Measurements were taken at the hottest region and least hot region on each disk. The Software indicates the maximum and minimum temperatures in the area selected for study. We collected and compared only the maximum temperature from each selected region. Data were developed and analyzed using Microsoft Excel to collect the data and create graphs. The rate of heating at the center of each disk was compared. Graphs were made of the rate of heating for samples of interest (FIG. 6). The differential of the temperature measurements between the center hottest point and the coolest edge section of each disk was compared across time as well (FIG. 7).

The center portion of the porous heat conductive Makrolon TC8030 heated faster than either the injection molded non porous, sample of the same material or the aluminum sample (FIG. 6).

The in plane thermal conductivity of a sample of the aluminum used in this experiment is between 100-300 W/mK. In comparison, the Makrolon TC8030 is much lower in the range of 25 W/mK. The effect of such a large amount of surface area increases the rate at which the porous material heats. The physics of heat flow is much higher in plane than through plane for this heat conductive polymer. For instance the through plane measurement is only 5 W/mK whereas the in plane measurement is 25 W/mK. This may explain why the heating rate for the high surface area porous plastic disk is faster. The surface area is considered in plane to the heat. Thus the heat moves easily on the surface of the porous plastic.

Another comparison observed in this experiment is seen in FIG. 7 which illustrates the temperature differential between the center hottest section of the disks and the edge section of the disk. If the samples were to heat up very uniformly, then the differential would be very low during the time frame of the test. If the samples are much hotter in the center and cooler on the edge of the disk where they are not in immediate contact with the smaller 25.4 mm aluminum square they sit on, that would indicate the samples are dissipating the heat generated at the center contact point.

FIG. 7 shows that the nonporous disks from either aluminum or the heat conductive Makrolon TC8030 injection molded disk have a similar heat profile across the disk. These disks have the same surface area comparatively. The porous Makrolon TC8030 disk has a much higher temperature differential across the disk, especially at the beginning of the heating cycle. This porous disk has a much higher level of surface area compared to the nonporous disks of either aluminum or Makrolon TC8030. The porous Makrolon TC8030 disk works very effectively at moving and dissipating heat. This sample is an excellent example of the advantages of a heat conductive porous plastic material. This material could be very useful in any device that requires heat dissipation.

### EXAMPLE 4

In this test, heat was transferred to an aluminum and similar heat conductive porous plastic heat sink with embedded heat spreader of approximately 101.6 mm outer diameter by approximately 76.2 mm tall with approximately 20-25.4 mm fins equally spaced around a 50.8 mm open central well with one closed end. Heat was applied to an approximate 25.4 mm square section of the center of the closed end of the heat sink to simulate an electronic heat source such as an LED chip or microprocessor. After about 20 minutes, reaching full equilibrium, the aluminum heat sink was almost a uniform temperature indicating good conduction, but convection was the limiting factor. Conversely, the heat conductive porous plastic with heat spreader heat sink had a fairly uniform temperature gradient away from the heat source, indicating an excess of surface area that allowed overall better convection (note temperature near the heat source was almost identical for both).

### EXAMPLE 5

The thermally conductive porous plastic samples were prepared by first filling a cast aluminum mold with the TC8030 micropelletized at 0.965 mm die size pellets. The mold was filled, and then closed and was placed under pressure between two electronic platens at a temperature 343° C. for 6 minutes. The mold was allowed to cool to room temperature and then the sintered parts were removed.

For samples that were co-processed with Graftech paper, a sample of Graftech paper at either 0.127 mm thick or 0.51 mm thick was cut using a clicker press and circular shaped die. A single circle of the Graftech paper was inserted in the disk shaped mold prior to the filling and processing of the TC8030 pellets. The same process temperature and settings were used to make the samples with Graftech paper as above.

Samples of aluminum were simply cut from cast aluminum using machining technology to comparable dimensions of the thermally conducive porous plastic. For instance 50.8 mm diameter disks were cut and polished to either 3 mm thick or 14 mm thick depending if we tested for volume or weight. The sample made with extra surface area was initially cut to 5-6 mm thick and then channels were cut into the disk to a depth of 3 mm from bottom. This was done until the weight of the 50.8 mm diameter aluminum disk equaled that of the 14 mm thermally conductive porous plastic disk. All of the aluminum disks were painted black with a heat resistance engine spray paint in order to facilitate a similar emissivity to the black porous plastic to allow accurate comparison via a thermal imaging camera. The disk shaped samples were tested by heating them on a 25.4 mm square aluminum block sitting on a hot plate and observing the heating rate and heat distribution across the surface of the disks. When tested on a heat source using a thermal imaging camera, the sintered porous plastic with heat spreader composite heated up much faster than a similar sintered part without the embedded graphite heat spreader. In addition, the porous plastic with embedded heat spreader heated up faster and more uniformly than the exact same combination that was loosely assembled. The lack of good interfacial contact created added thermal resistance that prohibited the combination from performing as well as the combination that was laminated via the sintering process. A picture of the interface between the Graftech paper co-processed into the thermally conductive porous plastic shows the interface is so good that the surface topography details of the porous plastic below the Graftech paper are visible on the top surface of the Graftech paper. (See FIG. 9).

A standard lab hot plate (Thermolyne Type #1900) with an upper surface of 20.3 cm×20.3 cm was plugged in and set for 104° C. The samples were placed on the aluminum blocks simultaneously in order to compare the rate of heating. Those aluminum blocks were allowed to preheat on the surface of the hot plate for 20 minutes prior to beginning the heating rate test. The porous plastic disks were placed on the surface of the hot plate using a sheet of paper to slide them on, so that they all contacted the surface at the same time. A FLIR T 400 model thermal imaging camera was used to collect temperature data across time with collection points at 10 second intervals as the samples heated up on the hot plate (FLIR Systems, Boston, Mass.). FLIR quick report software was used to analyze the images taken across time and the data was graphed.

### EXAMPLE 6

Comparison of Heating Profiles of Aluminum Block, Aluminum with Beveled Surface and a Porous Plastic Disk with Embedded Graftech Graphite Paper in a Hot Plate Test

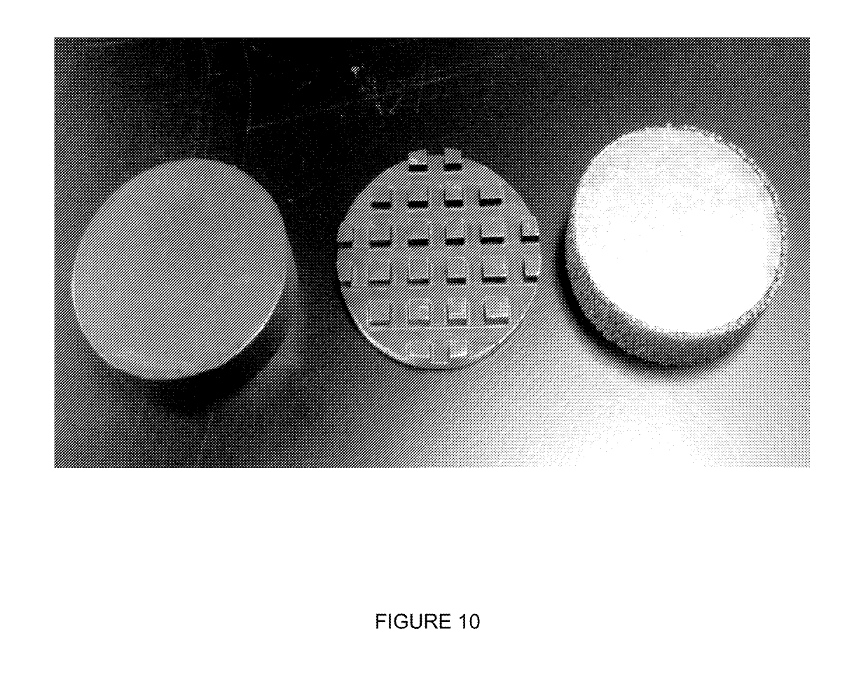

Three samples were compared: a sample of aluminum 14 mm thick and 50.8 mm in diameter weighing 79.5 gm; an aluminum disk (50.8 mm diameter) with a beveled surface to increase surface area weighing 21.40 gm; and, a disk of thermally conductive porous plastic made from Makrolon® TC8030 polycarbonate with a co-processed layer of Graftech paper 0.125 mm thick and weighing 21.30 gm also 50.8 mm diameter by 14 mm thick (FIG. 10).

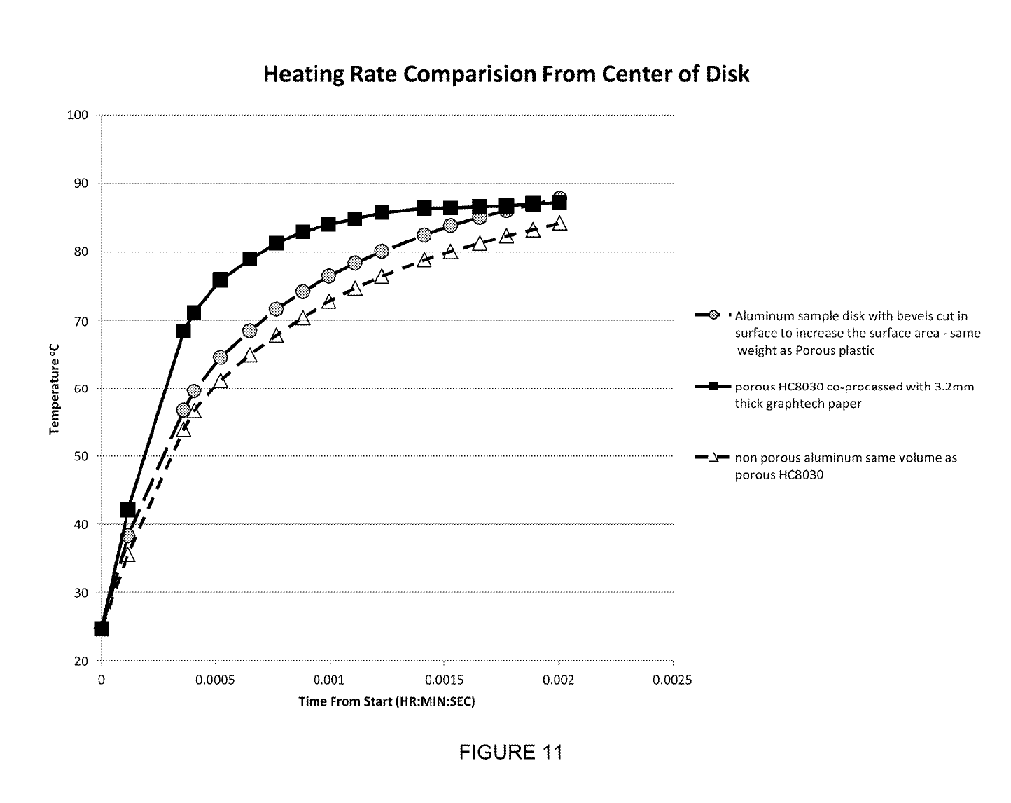

FIG. 11 shows that the thermally conductive porous plastic laminated to the Graftech paper (weight of 21.30 gm) heats at the fastest rate in comparison with an aluminum disk the same volume as the porous plastic disk. The aluminum disk at the same volume of the porous plastic disk weighs 79.5 gm. The aluminum disk has a much higher total heat capacity due to its higher mass. In comparison the last sample tested here is an aluminum disk with bevels cut in the surface that weighs the same as the porous plastic disk at 21.40 gm. This smaller aluminum disk had a similar heating rate compared to the larger aluminum disk, and a slower rate of heating than the porous plastic disk with the Graftech layer co-processed with the porous plastic. This result indicates that a combination of a highly heat conductive material such as the Graftech paper laminated in extremely good contact with a heat conductive porous plastic creates a functional heat sink. In a gram per heat dissipation comparison, the porous plastic with heat spreader is the most efficient embodiment. This weight reduction advantage would be particularly advantageous in mobile electronic devices such as laptop computers or in hung weight applications such as overhead lighting.

### EXAMPLE 7

Comparison of Heating Profiles of a Thermally Conductive Porous Plastic Disk, a Thermally Conductive Porous Plastic Disk with Embedded Graftech Paper, and a Thermally Conductive Porous Plastic Disk Placed on Graphite Paper in a Hot Plate Test

Three samples were compared: a thermally conductive porous plastic disk weighing 21.06 gm; a second disk of the same thermally conductive porous plastic co-processed with a layer of 0.51 mm thick Graftech paper to create a laminate; and, a disk of the thermally conductive porous plastic simply placed on top of a layer of 0.51 mm thick Graftech paper (all 14 mm thick×50.8 mm diameter).

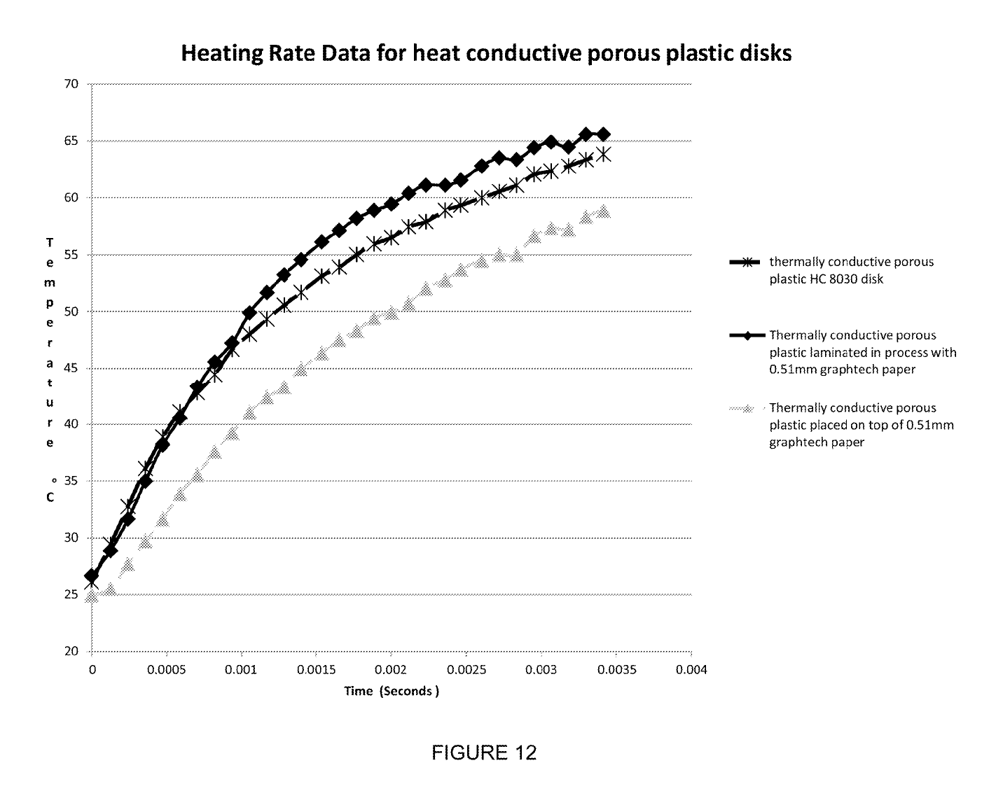

FIG. 12 shows that the fastest heating rate was the thermally conductive porous plastic disk laminated in process with a layer of Graftech paper. Interestingly the sample of the thermally conductive porous plastic disk placed on top of the Graftech paper had the slowest heating rate. The small amount of air present between the thermally conductive porous plastic and the Graftech paper likely reduced the heat transfer from the paper to the porous plastic. The sample of plain thermally conductive porous plastic had a heating rate between the co-processed laminate of porous plastic and Graftech paper, and the porous plastic just placed on the Graftech paper. For the heat spreader to function in this example the Graftech paper laminate must be extremely close with little to no space between the heat spreader Graftech paper and the thermally conductive porous plastic heat sink.

### EXAMPLE 8

Comparison of Heating Profiles of a Thermally Conductive Porous Plastic Disk, a Thermally Conductive Porous Plastic Disk with Embedded Graftech Paper, and a Thermally Conductive Porous Plastic Disk Placed on Graphite Paper in a Hot Plate Test

Three samples were compared: a thermally conductive porous plastic disk weighing 21.06 gm; a second disk of the same thermally conductive porous plastic co-processed with a layer of 0.127 mm thick Graftech paper to create a laminate; and, a disk of the thermally conductive porous plastic simply placed on top of a layer of 0.127 mm thick Graftech paper (all 14 mm thick×50.8 mm diameter).

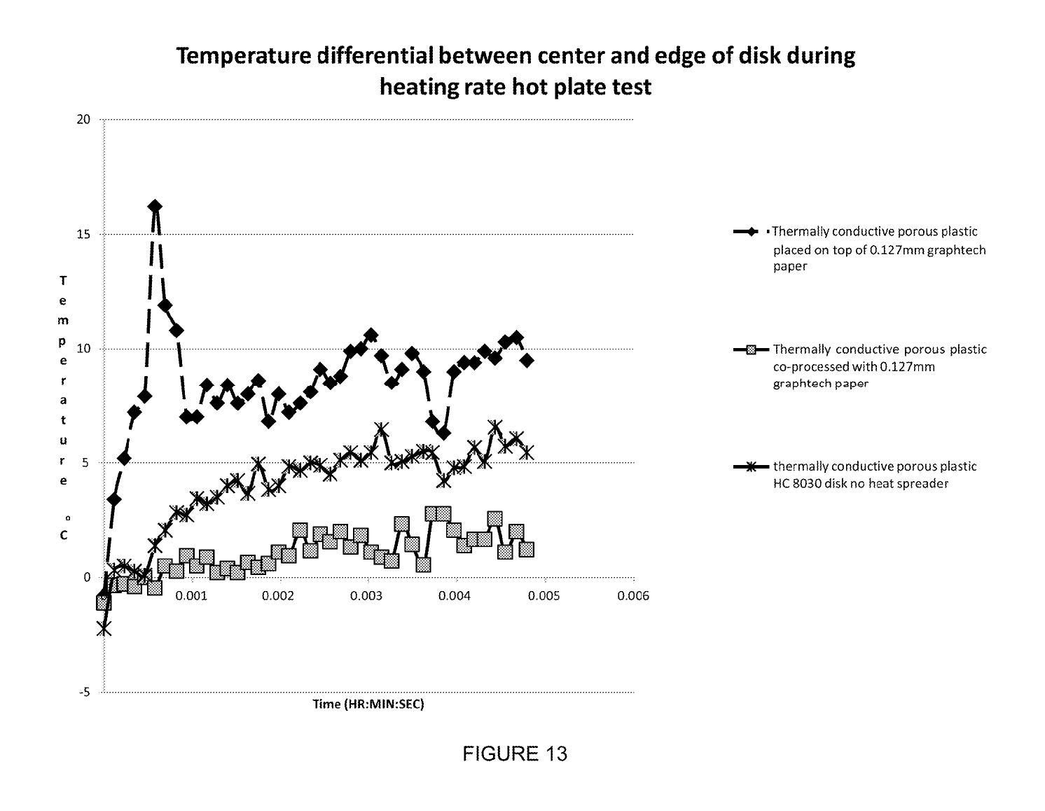

The samples were tested on the aluminum blocks on the hot plate and results analyzed for temperature differential during heating from the hottest point on the disk to the coolest point on the disk. The results are shown in FIG. 13 and indicate that the sample placed on top of the Graftech paper had a higher differential in temperature at the beginning of the test. The Graftech paper thermal interface layer is not in close contact with the thermally conductive porous plastic heat sink, so the heat cannot distribute evenly across the heat sink. In fact, the sample placed on the Graftech paper acted like the thermally conductive porous plastic disk with no heat spreader, except at the start of the test, where the layering seemed to impede the even distribution of heat. The sample of thermally conductive porous plastic with the co-processed heat spreading Graftech paper showed the most uniform heat distribution. This indicates that the heat sink is being used optimally, as it heats uniformly and fastest. The testing indicates that a properly laminated thermal interface material can create a heat sink that functions comparatively to an aluminum heat sink.

### EXAMPLE 9

Comparison of Heating Profiles of a Standard Non-Porous Aluminum Disk, a Non-Porous Thermally Conductive Plastic Disk, and a Thermally Conductive Porous Plastic Disk with Embedded Graftech Paper

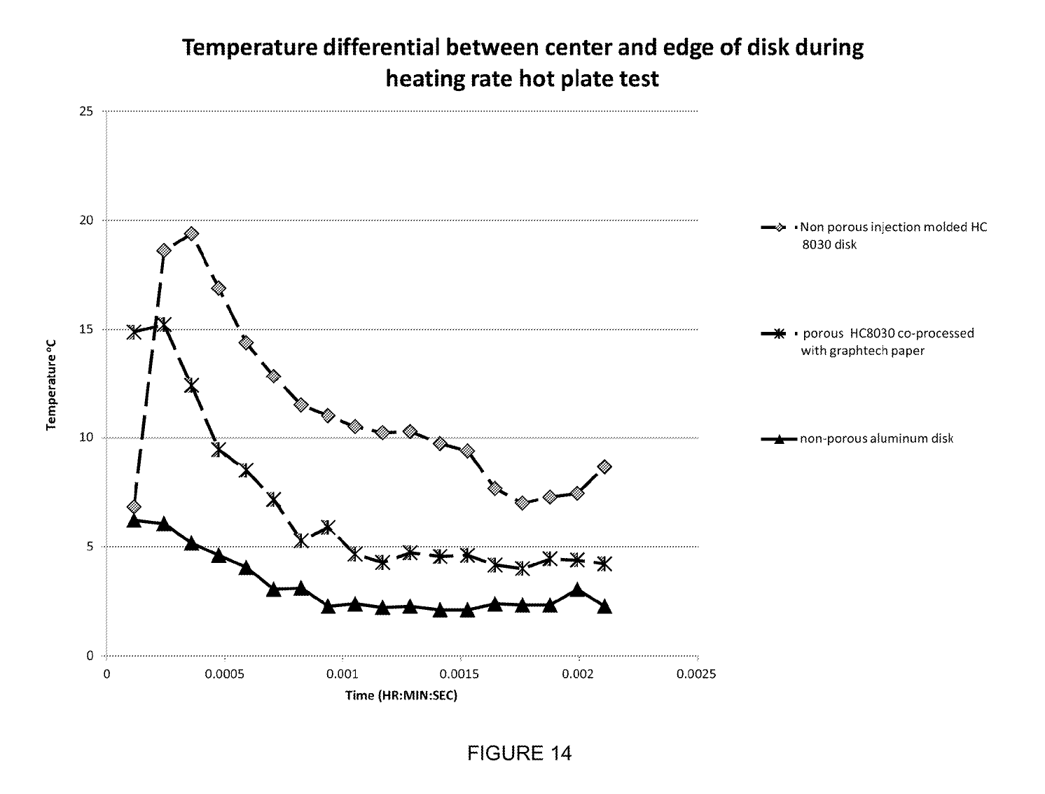

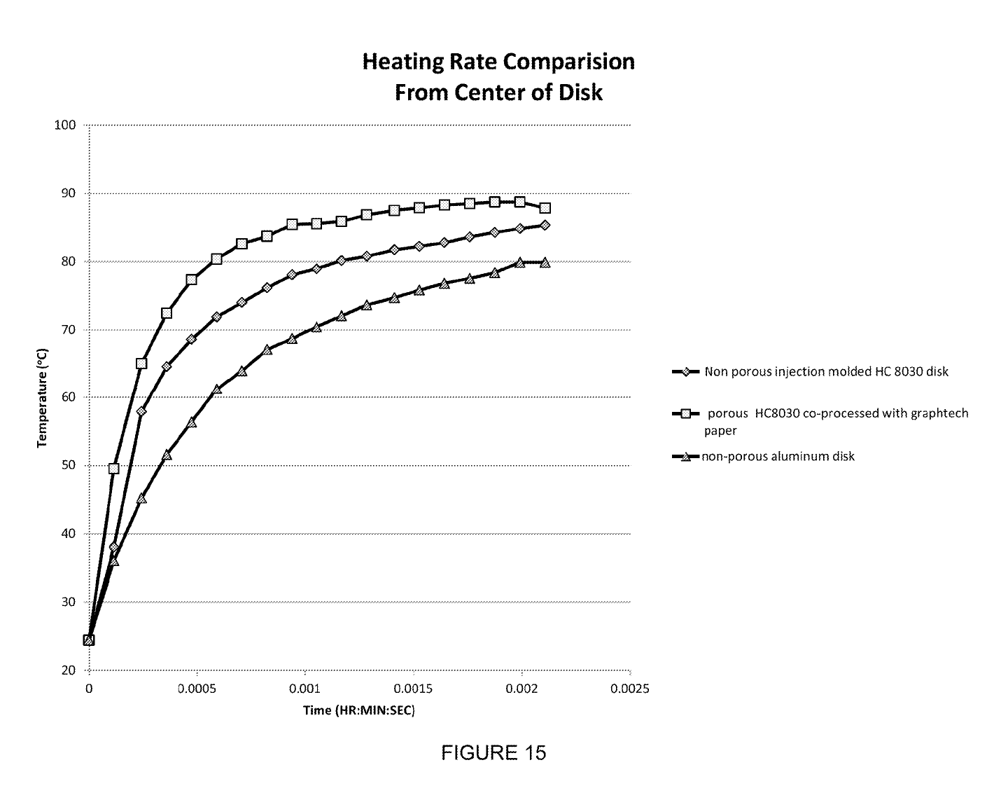

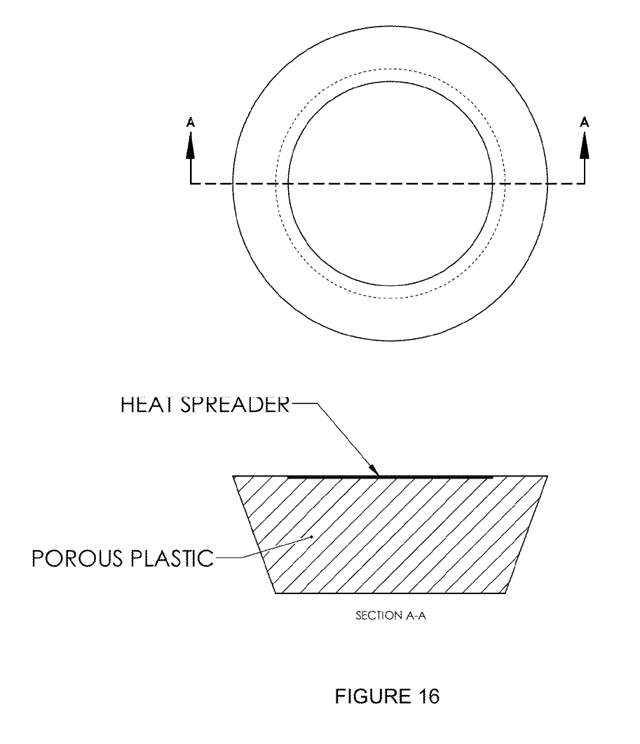

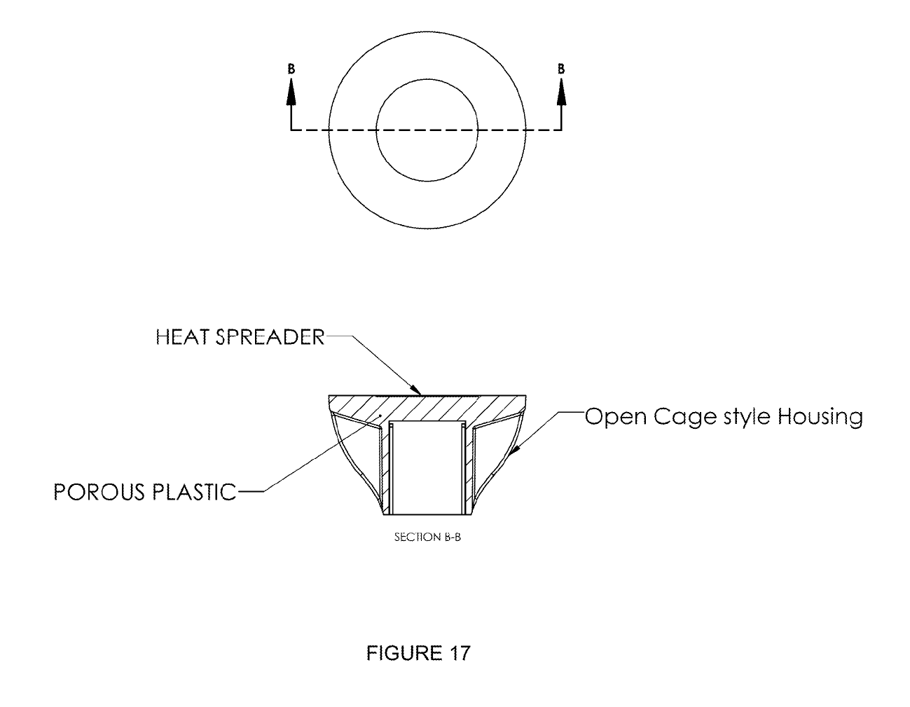

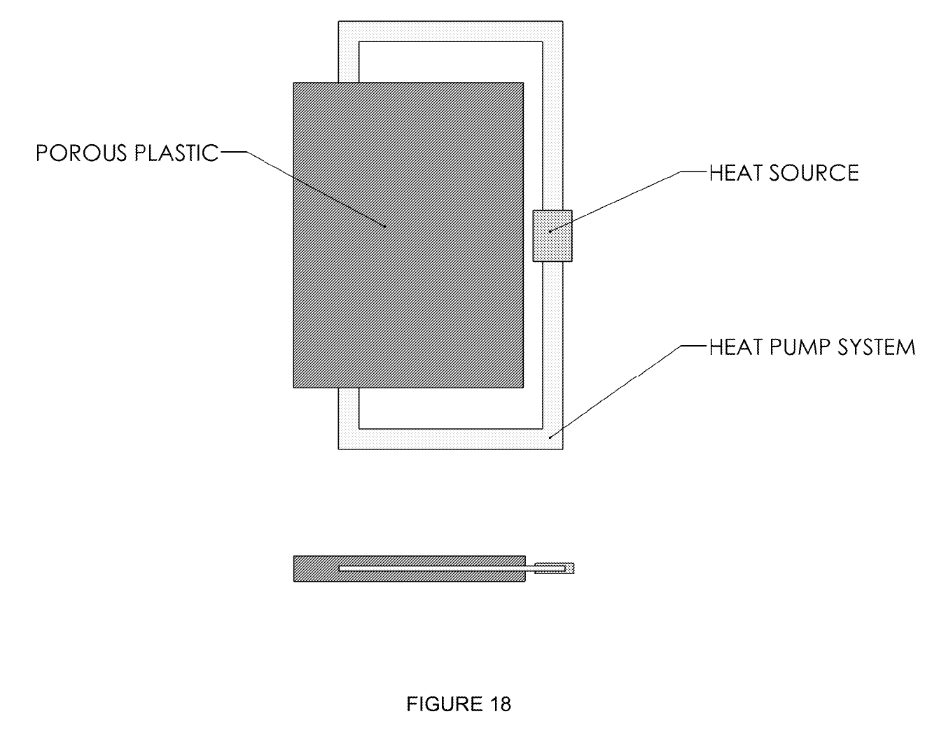

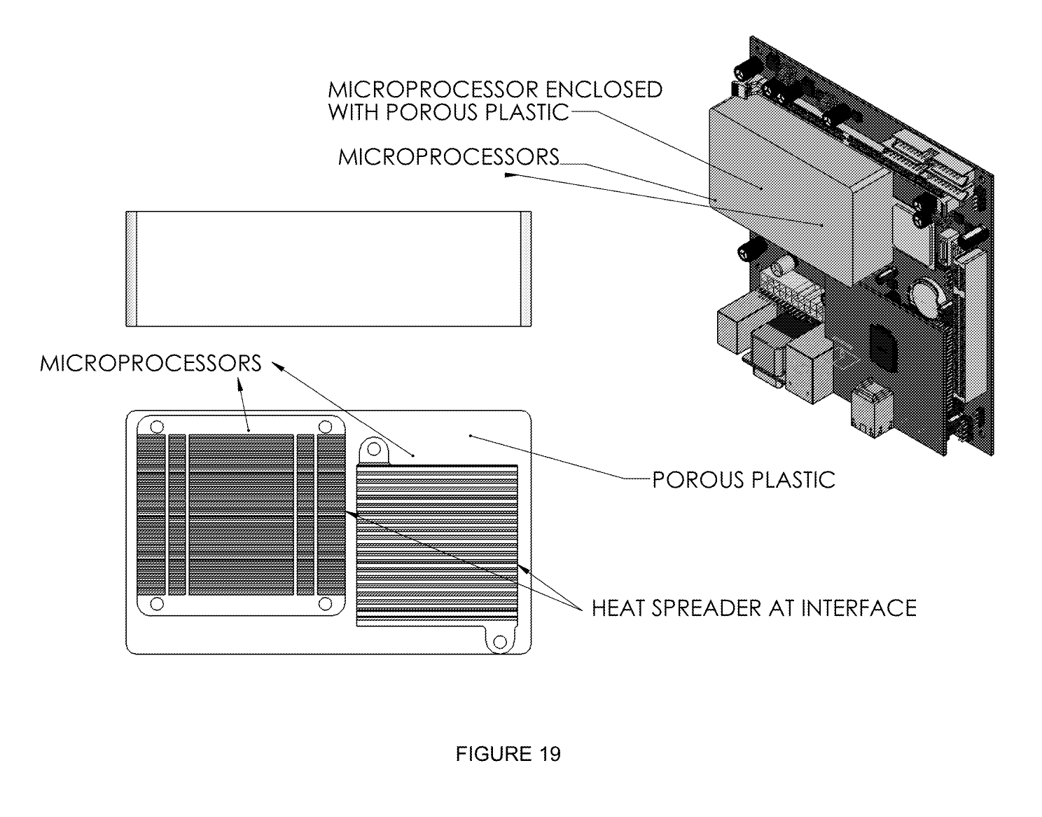

Three samples were compared: a standard aluminum disk; a nonporous thermally conductive plastic disk; and, a thermally conductive porous plastic disk, co-processed with a layer of Graftech paper as a thermal interface material (all 50.8 mm diameter, 3 mm thick). The temperature differentials are presented in FIG. 14. The heating rates between the center and the edge of each disk are shown in FIG. 15.

The temperature differential and heating rate for the co-processed laminate of thermally conductive porous plastic and Graftech paper provide for the best performance. The temperature differential was lower than the nonporous thermally conductive plastic disk, in fact within one minute of starting the test, the temperature differential was almost as low as the aluminum disk. The heating rate was faster for the co-processed laminate. Overall the performance of the co-processed laminate of thermally conductive porous plastic combined with a heat spreader as effective as the Graftech paper created a fully utilized fast heat sink.

### EXAMPLE 10

### Comparison of Heating Dissipation Profiles of a Standard Non-Porous Aluminum Disk, a Non Porous Thermally Conductive Disk, a Non-Thermally Conductive Porous Plastic Disk, and a Thermally Conductive Porous Plastic Disk.

Four samples were compared: a standard non-porous aluminum disk; a nonporous thermally conductive plastic disk (injection molded Bayer Makrolon TC8030); a non-thermally conductive plastic disk (sintered polyethylene); and a thermally conductive porous plastic disk (sintered Bayer Makrolon TC8030) (all 50.8 mm in diameter and 3 mm thick).

A set of four aluminum heater disks were created using a 6.35 mm thick aluminum stock at a diameter of 44.45 mm. The aluminum disks were fixed with two longitudinal slots though the midsection of the disk for placement of one thermocouple and one heater rod. Each disk contained one Watlow brand heater rod 1.59 mm diameter 25 watt cartridge heater and a single thermocouple from Pyromation Corp and distributed by Fancher under ID #JRS3-F3B096-3. These disk heaters were connected to a power source and heated to 40% of their capacity. The temperature averaged 138° C. when reaching a steady state heating state. Four heat sink samples were attached to the aluminum heaters. The temperatures of the heaters at steady state were recorded. The differences between the steady state temperatures with and without a heat sink were compared and recorded. The temperature difference was divided by the heat sink weight. The data were collected 40 minutes after the heating started.

The temperature differentials based on per unit of weight for four heat sink materials are presented in table 2. The data indicate that the sintered porous thermally conductive disks have the highest heat dissipation capability per weight unit. Non-thermally conductive porous media have the similar heat dissipation capability as the solid non-porous thermally conductive media based on per weight unit. This data prove that open cell thermally conductive porous media are effective heat dissipation media.

TABLE 2
Heat dissipation per gram of heat sink materials

| | Temperature |
|---|---|
| Materials | difference (° C.)/gram sample |
| Non-porous aluminum | 2.2 |
| Non-porous thermally conductive plastic | 4.2 |
| Non-thermally conductive sintered porous | 4.2 |
| polyethylene | |
| Thermally conductive sintered porous | 5.5 |
| plastic | |

### EXAMPLE 11

Comparison of Heating Dissipation Profiles of a Standard Non-Porous Aluminum Disk, a Non Porous Thermally Conductive Disk, a Non-Thermally Conductive Porous Plastic Disk, and a Thermally Conductive Porous Plastic Disk Under 6.5 Liter/min Air Flow Conditions.

Four samples were compared: a standard non-porous aluminum disk; a nonporous thermally conductive plastic disk (injection molded Bayer Makrolon TC8030); a non-thermally conductive plastic disk (sintered polyethylene); and a thermally conductive porous plastic disk (sintered Bayer Makrolon TC8030) (all 50.8 mm in diameter and 3 mm thick).

A set of four aluminum heater disks were created using a 6.35 mm thick aluminum stock at a diameter of 44.45 mm. The aluminum disks were fixed with two longitudinal slots though the midsection of the disk for placement of one thermocouple and one heater rod. Each disk contained one Watlow brand heater rod 1.59 mm diameter 25 watt cartridge heater and a single thermocouple from Pyromation Corp and distributed by Fancher under ID #JRS3-F3B096-3. These disk heaters were connected to a power source and heated to 40% of their capacity. The temperature averaged 138° C. when reaching a steady state heating state. Four heat sink samples were attached to the aluminum heaters. 6.5L/min air flow at room temperature was applied vertically to the surface of heat sink with a plastic tube. The temperatures of the heaters at steady state were recorded. The differences between 138° C. steady state temperatures without a heat sink were compared to temperatures with the heat sink were recorded. The temperature difference was divided by the heat sink weight. The data were 40 minutes after the heating started.

The temperature differentials based on per unit of weight for four heat sink materials are presented in table 3. The data indicate that sintered porous heat sink disks have much higher heat dissipation capability per weight unit than nonporous thermally conductive heat sinks under the forced air conditions. The porous thermally conductive heat sink disk had the highest heat dissipation capability. These data prove that open cell porous media are effective heat dissipation media by providing an internal air circulation.

TABLE 3
Heat dissipation per gram of heat sink materials at 6.5 L/min air flow

| | Temperature |
|---|---|
| Materials | difference (° C.)/gram sample |
| Non-porous aluminum | 4.4 |
| Non-porous thermally conductive plastic | 7.2 |
| Non-thermally conductive sintered porous | 11.7 |
| polyethylene | |
| Thermally conductive sintered porous | 13.9 |
| plastic | |

All patents, publications and abstracts cited above are incorporated herein by reference in their entirety. It should be understood that the foregoing relates only to preferred embodiments of the present invention and that numerous modifications or alterations may be made therein without departing from the spirit and the scope of the present invention as defined in the following claims.

1. A thermally conductive porous plastic composition comprising:
a plastic; and,
a conductive filler, wherein the thermally conductive porous plastic composition has an in-plane thermal conductivity greater than 0.5W/mK.

2. The thermally conductive porous plastic composition of claim 1, wherein the plastic is polyethylene, polypropylene, polyester, acrylonitrile butadiene styrene (ABS), polycarbonate, polyamide, polyphenylene oxide, polyphenylene sulfide, phenolic resin, polyethylene terephthalate, polybutylene terephthalate, or epoxy, or a combination thereof

3. The thermally conductive porous plastic composition of claim 1, wherein the conductive filler is compounded in the plastic.

4. The thermally conductive porous plastic composition of claim 1, wherein the conductive filler comprises a metallic material, a non-metallic material or a ceramic material or a combination thereof.

5. The thermally conductive porous plastic composition of claim 1, further comprising a heat spreading interfacial material.

6. The thermally conductive porous plastic composition of claim 5, wherein the heat spreading interfacial material comprises a metallic material, a non-metallic material or a ceramic material.

7. The metallic material of claim 4, wherein the metallic material is aluminum, copper, ferrous materials, zinc, tin or an alloy of these metals.

8. The non-metallic material of claim 4, wherein the non-metallic material is heat conductive graphite, graphene, thermal grease or quartz.

9. The ceramic material of claim 4, wherein the ceramic material is boron nitride, silicon carbide or aluminum nitride.

10. The composition of claim 9, wherein the thermally conductive porous plastic composition is electrically insulating.

11. The thermally conductive porous plastic composition of claim 1, wherein the plastic is sintered.

12. The thermally conductive porous plastic composition of claim 5, wherein the plastic and the heat spreading interfacial material are sintered.

13. The thermally conductive porous plastic composition of claim 1 having an average pore size from 1 μm to 500 μm, from 5 μm to 400 μm, or from 10 μm to 300 μm.

14. The thermally conductive porous plastic composition of claim 1 having an average porosity from 10% to 70%.

15. The thermally conductive porous plastic composition of claim 1 having a density from 0.2 g/cm³ to 6 g/cm³.

16. The thermally conductive porous plastic composition of claim 1 having a surface area from 0.0001 m²/g to 10 m²/g.

17. An electrical device comprising the thermally conductive porous plastic composition of claim 1.

18. The electrical device of claim 17, wherein the device is a computer, cell phone, light, light emitting diode, a device employing a light emitting diode or a hand held electronic device.

19. A housing for a light emitting diode device comprising the thermally conductive porous plastic composition of claim 1.

20. A method of dissipating heat from a heat source comprising:
placing the thermally conductive porous plastic composition of claim 1 in proximity to a heat source;
permitting air to move through the thermally conductive porous plastic composition;
dissipating heat from the heat source through the thermally conductive porous plastic composition.

21. The method of claim 20 further comprising:
placing the thermally conductive porous plastic composition adjacent to a heat spreading interfacial material before step a; and,
placing the heat spreading interfacial material in proximity to the heat source.

22. The method of claim 20, wherein the heat source is in an electrical device.

23. The method of claim 22, wherein the electrical device is a computer, cell phone, light, light emitting diode, a device employing a light emitting diode or a hand held electronic device.
